(19) United States
(12) Patent Application Publication
(10) Pub. No.: US 2018/0108000 A1
(43) Pub. Date: Apr. 19, 2018

(54) SYSTEMS AND METHODS FOR GENERATING AGGREGATED MERCHANT ANALYTICS FOR A GEOGRAPHIC SECTOR USING TIP DATA

(71) Applicant: MasterCard International Incorporated, Purchase, NY (US)

(72) Inventors: Manash Bhattacharjee, Jersey City, NJ (US); Debashis Ghosh, Charlotte, NC (US); Prashanna S. Tiwaree, New York, NY (US)

(21) Appl. No.: 15/296,644

(22) Filed: Oct. 18, 2016

(51) Int. Cl. G06Q 20/20; G06Q 20/12

(52) U.S. Cl. CPC G06Q 20/202; G06Q 20/12

(57) ABSTRACT

A merchant analytics computing device for generating aggregated merchant analytics for a geographic sector using tip data is provided. The merchant analytics computing device is programmed to define a plurality of geographic sectors and receive transaction data occurring within a period of time. The transaction data is associated with merchants located in the sector and includes authorization and clearing transactions. The merchant analytics computing device is programmed to match a plurality of authorization and clearing transactions, calculate a tip size for each matched transaction, identify the sector for each merchant, and generate aggregated merchant analytics for each sector based on the transaction data. The aggregated merchant analytics represent a ranking of each sector relative to all other sectors of the plurality of sectors and include at least a tip size score based on the calculated tip size. The merchant analytics computing device displays on a user device the aggregated analytics.

### BACKGROUND

The field of the disclosure relates generally to generating merchant analytics, and, more specifically, to network-based methods and systems for generating gratuity-based merchant analytics and causing the merchant analytics to be displayed on a user interface.

There are many parties interested in the number and types of merchants engaged in business within particular neighborhoods. Many of these same parties and some other parties may also be interested in the relative socioeconomic status of those neighborhoods. Unfortunately, it is difficult to measure these characteristics in a manner that easily allows for a comparison of one neighborhood to other neighborhoods. In particular, it is extremely difficult to discern which neighborhoods demonstrate key business characteristics—such as growth rate, revenue stability, consumer traffic, consumer affluence, merchant caliber—relative to other neighborhoods. A system is needed that provides a more reliable metric to compare and contrast the makeup and status of one neighborhood as compared to other neighborhoods.

### BRIEF DESCRIPTION

In one aspect, a merchant analytics computing device for generating aggregated merchant analytics for a geographic sector using tip data is provided. The merchant analytics computing device includes a memory in communication with a processor. The processor is programmed to define a plurality of sectors of a geographic region. The processor is further programmed to receive transaction data for financial transactions occurring within a period of time, the transaction data associated with a plurality of merchants, the plurality of merchants located in the geographic region, the transaction data including authorization transactions and clearing transactions. The processor is further programmed to match, for each merchant of the plurality of merchants, a plurality of authorization transactions with a respective plurality of clearing transactions, calculate a tip size for each of the plurality of matched transactions, and identify, for each merchant of the plurality of merchants, one sector of the plurality of sectors in which the merchant is located. The processor is still further programmed to generate aggregated merchant analytics for each sector based on the transaction data associated with all merchants of the plurality of merchants located in the sector, wherein the aggregated merchant analytics represent a ranking of each sector relative to all other sectors of the plurality of sectors, the aggregated merchant analytics including at least a tip size score based on the calculated tip size. The processor is also programmed to display on a user interface of the user computing device the aggregated merchant analytics, wherein the aggregated merchant analytics are graphically represented on a map of the defined sectors.

In another aspect, a method for generating aggregated merchant analytics for a sector is provided. The method is implemented by a merchant analytics computing device including at least one processor in communication with a memory. The merchant analytics computing device is in communication with a user computing device. The method includes defining a plurality of sectors of a geographic region. The method further includes receiving, by the merchant analytics computing device, transaction data for financial transactions occurring within a period of time, the transaction data associated with a plurality of merchants, the plurality of merchants located in the geographic region. The method still further includes identifying, for each merchant of the plurality of merchants, one sector of the plurality of sectors in which the merchant is located, and generating, by the merchant analytics computing device, aggregated merchant analytics for each sector based on the transaction data associated with all merchants of the plurality of merchants located in the sector, wherein the aggregated merchant analytics represent a ranking of each sector relative to all other sectors of the plurality of sectors. The method also includes displaying, by the merchant analytics computing device, on a user interface of the user computing device the aggregated merchant analytics, wherein the aggregated merchant analytics are graphically represented on a map of the defined sectors.

In a further aspect, a computer-readable storage medium having computer-executable instructions embodied thereon is provided. When executed by a merchant analytics computing device including at least one processor in communication with a memory, the computer-executable instructions cause the merchant analytics computing device to define a plurality of sectors of a geographic region. The computer-executable instructions cause the merchant analytics computing device to receive transaction data for financial transactions occurring within a period of time, the transaction data associated with a plurality of merchants, the plurality of merchants located in the geographic region. The computer-executable instructions cause the merchant analytics computing device to identify, for each merchant of the plurality of merchants, one sector of the plurality of sectors in which the merchant is located, and generate aggregated merchant analytics for each sector based on the transaction data associated with all merchants of the plurality of merchants located in the sector. The aggregated merchant analytics represent a ranking of each sector relative to all other sectors of the plurality of sectors. The computer-executable instructions cause the merchant analytics computing device to display on a user interface of a user computing device the aggregated merchant analytics, wherein the aggregated merchant analytics are graphically represented on a map of the defined sectors.

### BRIEF DESCRIPTION OF THE DRAWINGS

FIGS. 1-12 show example embodiments of the methods and systems described herein.

FIG. 1 is a schematic diagram illustrating an example multi-party payment system for enabling payment-by-card transactions and generating aggregated merchant analytics in accordance with one embodiment of the present disclosure.

FIG. 2 is an expanded block diagram of an example embodiment of a computer system used in processing payment transactions that includes a merchant analytics computing device in accordance with one example embodiment of the present disclosure.

FIG. 3 illustrates an example configuration of a server system such as the merchant analytics computing device of FIG. 2.

FIG. 4 illustrates an example configuration of a client system shown in FIG. 2.

FIG. 5 is a simplified data flow diagram for generating merchant analytics using the merchant analytics computing device of FIG. 2.

FIGS. 6-8 are example screenshots of a user interface of a user computing device, including merchant analytics generated by the merchant analytics computing device of FIG. 2.

FIG. 9 is a data flow block diagram illustrating an example of a process of calculating and analyzing gratuity data in accordance with an example embodiment of the present disclosure.

FIG. 10 is a simplified diagram of an example method for generating merchant analytics and displaying said analytics on a user interface using the merchant analytics computing device of FIG. 2.

FIG. 11 is a diagram illustrating an example of a gratuity analyzing method in accordance with an example embodiment of the present disclosure.

FIG. 12 is a diagram of components of one or more example computing devices that may be used in the environment shown in FIG. 2.

Although specific features of various embodiments may be shown in some drawings and not in others, this is for convenience only. Any feature of any drawing may be referenced and/or claimed in combination with any feature of any other drawing.

### DETAILED DESCRIPTION

The systems and methods described herein are directed to generating aggregated merchant analytics for a geographic sector using “gratuity” or “tip” data. These systems and methods are implemented using a geographic analytics platform. Tip or gratuity size can be a useful measure of a socioeconomic status of a geographic sector. For example, more affluent consumers may frequent higher-end restaurants and/or may tip more for meals at those restaurants. In one embodiment, the platform described herein is associated with or integral to a payment processing network that includes a payment processor that is configured to process payment transactions initiated by account holders or cardholders using payment cards (e.g., credit cards, debit card, prepaid cards, etc.). The payment processor collects transaction data associated with these transactions for processing. In the example embodiment, the platform includes a merchant analytics computing device configured to process the transaction data to calculate one or more sector scores associated with a geographic sector based on transactions initiated at merchants located within that geographic sector.

The sector score may include at least one of a growth score, a stability score, a size score, a ticket size score, a traffic score, a tip score, a composite score, and a sub-composite score for each sector. A “growth score” is a ranking of the growth of the sector relative to other sectors in the geographic region, wherein “growth” refers generally to sales revenue growth over a period of time. A “stability score” is a ranking of the stability of the sector, wherein “stability” refers generally to a maintenance of sales revenue within a range of sales revenues around an average. A “size score” is a ranking of the size of the sector, wherein “size” refers generally to total sales revenue. A “traffic score” is a ranking of the traffic of the sector, wherein “traffic” refers generally to a number of monthly transactions. A “ticket size score” is a ranking of the ticket size of the sector, wherein “ticket size” refers generally to a transaction amount, and may be calculated by dividing the size by the traffic (i.e., dividing sales revenue by the number of transactions). A “tip size” score is a ranking of the tip size of eating establishments within the sectors, wherein “tip size” refers generally to an amount of tip or gratuity added to a transaction amount. A “composite score” is a composite of at least some of the previous six scores (growth, stability, size, traffic, ticket size, and tip), to provide an overall ranking of the sector. A “sub-composite score” is a composite of the ticket size score and the tip size score. Where the general term “score” without a modifier is used herein, it may refer collectively to any or all of the preceding scores to describe characteristics shared by some or all of the scores. Each of these scores may be generated for each merchant located within a sector and may be subsequently aggregated to generate a sector score for the sector.

As used herein, “eating establishment” refers generally to any merchant serving food and/or beverages, such as fast food restaurants, “sit-down” restaurants, bars, eating establishments within other merchant locations (e.g., a café within a bookstore), etc. In at least some cases, an average tip size for a particular eating establishment may serve as a proxy for quality of service and/or for “caliber” of that eating establishment in a way that other transaction metrics (e.g., ticket size) may not. As one example, a high-end restaurant frequented by more affluent couples may have an average ticket size of $100 or more, and a family-style restaurant frequented by large families may also have an average ticket size of $100 or more. However, tip sizes may generally be larger (in amount and/or in percentage of a bill for a meal) at high-end restaurants that are more expensive, and tip sizes may be relatively smaller at more casual or family-oriented restaurants. Accordingly, sectors that have an aggregated average tip size that is relatively high may be assumed to have a greater number of higher-end restaurants and/or more affluent clientele.

The geographic analytics platform includes a merchant analytics computing device. The merchant analytics computing device includes a processor in communication with a memory. The merchant analytics computing device is configured to: (i) define a plurality of sectors of a geographic region; (ii) receive transaction data for financial transactions occurring within a period of time, the transaction data associated with a plurality of merchants, the plurality of merchants located in the geographic region, the transaction data including transaction authorization data and transaction clearing data; (iii) match, for each merchant of the plurality of merchants, a plurality of authorization data messages with a respective plurality of clearing data messages; (iv) calculate a tip size for each of the plurality of matched data messages; (v) identify, for each merchant of the plurality of merchants, one sector of the plurality of sectors in which the merchant is located; (vi) generate aggregated merchant analytics for each sector based on the transaction data associated with all merchants of the plurality of merchants located in the sector, wherein the aggregated merchant analytics represent a ranking of each sector relative to all other sectors of the plurality of sectors, the aggregated merchant analytics including at least a tip size score based on the calculated tip size; and (vii) display on a user interface of the user computing device the aggregated merchant analytics, wherein the aggregated merchant analytics are graphically represented on a map of the defined sectors.

### Sector Definition Phase

The merchant analytics computing device is configured to define a plurality of “merchant sectors,” “sector locations,” or “sectors” (used interchangeably herein). More specifically, the merchant analytics computing device is configured to divide up a geographic region (e.g., a country, state, city, county, etc.) into a plurality of sectors containing merchants therein (i.e., a subset of a plurality of merchants located within the geographic region). The sector may be defined by a geographic boundary containing the plurality of merchants therein. In an example embodiment, sectors are defined according to census blocks, and the geographic boundaries of a sector correspond to the geographic boundaries of the census block. In some embodiments, each sector includes a minimum of five merchants. Accordingly, where a sector is initially defined as a census block including fewer than five merchants, the geographic boundaries of the sector are expanded or adjusted to include at least one additional census block until the sector includes at least five merchants. In some embodiments, each sector may include up to n merchants, where n is an integer greater than five.

As described above, sectors may be defined on a geographic scale as small as a census block (which may be as small as a city block). However, sectors at the census block level may be “rolled up” or aggregated into larger, block-group level sectors, which may correspond to block groups as defined by the United States Census Bureau. Block-group level sectors may be rolled up or aggregated into large sectors, such as city- or county-level sectors, which themselves may be rolled up or aggregated into state- or nation-level sectors. The (geographic) size of the sectors may depend, in an example embodiment, on a user's view of a map on an interactive user interface, the map displaying the defined sectors. For example, is a user is viewing an entire nation, the sectors may be displayed at a state level. If the user is viewing a particular county, the sectors may be displayed at a block-group or block level.

In some embodiments, sectors are defined to have a minimum number of eating establishments or other merchants. For example, each sector includes a minimum of fourteen eating establishments. In alternative embodiments, each sector includes a greater or lesser minimum number of eating establishments. In some embodiments, sectors are defined such that no single eating establishment within the sector accounts for forty percent or more of the total sales of all eating establishments within the sector. In alternative embodiments, this maximum is higher or lower. The definition of the sectors provides for anonymization of the data.

As will be described further herein, the merchant analytics computing device is configured to determine “aggregated merchant analytics” for each sector based at least in part on received transaction data for the merchants located in the sector. The merchant analytics are indicative of the financial success of the sector relative to other sectors in that geographic region. For example, the merchant analytics computing device rank or score a sector relative to other sectors in a county or in a state. In one example embodiment, the merchant analytics computing device is configured to determine and provide merchant analytics, which may include a numerical score, for a sector based on aggregated merchant analytics for individual merchants located within the sector. For example, if a sector includes five merchants, the merchant analytics computing device may process transaction data for each individual merchant to generate analytics for each particular merchant. The merchant analytics computing device may then aggregate the individual analytics to determine “aggregated merchant analytics” for the sector as a whole. A weighted average may also be used, which may give more weight to certain merchants in the sector. Alternatively, the merchant analytics computing device may determine the aggregated merchant analytics for the sector using any other aggregation or combination of the individual merchant analytics.

The merchant analytics computing device may define or establish the sectors before receiving the transaction data. For example, the merchant analytics computing device may use available public information (e.g., census data) to define sectors, each sector including at least five merchants located therein, as described above. In some other embodiments, the merchant analytics computing device may define the sectors using the received transaction data. For example, the merchant analytics computing device may use merchant identifiers included in the transaction data to identify a location of each merchant, and then define the sectors.

The merchant analytics computing device may store transaction data, defined sectors, and/or merchant analytics (aggregated and/or individual) in a database. Each merchant for which associated transaction data and/or scores are stored may be indexed or identified in the database by at least one sector identifier and/or by merchant industry. Accordingly, the merchant analytics computing device may be configured to not only provide analytics for sectors, but may also be configured to provide analytics for particular industries and/or for particular merchants within that industry. For example, the merchant analytics computing device may generate merchant analytics for a plurality of sectors in Charlotte, N.C., USA, relative to other sectors in North Carolina and may generate analytics for a particular eating establishment in Charlotte relative to other eating establishments in the city of Charlotte, the state of N.C., or the United States. Moreover, a particular merchant may be indexed by (i.e., be located in) multiple sectors. For example, a merchant at Charlotte-Douglas Airport may be included in a “block” sector (named as such because such a sector may take up an area as small as a city block, in some embodiments the smallest available sector division), a “block group” sector (representative of an area that is small but that includes at least one “block” sector, for example, a census tract), a Mecklenburg County sector, a Charlotte (city) sector, a N.C. sector, and a United States sector.

### Setup Phase

In the example embodiment, the merchant analytics computing device is configured to receive information describing a merchant in a merchant management portfolio during a configuration period referred to as a “Setup Phase”. In an example embodiment, a user (e.g., a commercial real estate owner or lender, a business owner, or marketing director) may access the merchant analytics computing device (directly or via any suitable client user computing device in communication with the merchant analytics computing device) and may provide such information. Information describing or associated with particular merchants may be referred to as “merchant definitions,” and may be used to identify and/or evaluate (e.g., score) each merchant. Merchant definitions include information associated with merchant locations including property identifiers, property location information, and merchant classification information. In some implementations, merchant definitions may further include information relating to the real estate asset or property of which the merchant is a tenant. For example, merchant definitions may further include pricing of a real estate asset, vacancy factors of the asset, square footage of the asset, tax information associated with the asset, and other data that may be used to adjust the analytics (e.g., valuation) of a tenant merchant and/or of a real estate asset. The user may also provide various other data associated with the user (“user data”). For example, in implementations in which the user is associated with a business (e.g., a merchant), the user may import or provide various metrics associated with the business, including budgets, marketing data, and/or goals (e.g., increase growth, increase ticket size, increase traffic).

As used herein, “merchant management portfolio” (alternately referred to as a “portfolio”) refers to a collection of merchants in different locations but managed by one entity or user, generally. In the example embodiment, a merchant management portfolio may be described by merchant definitions and/or user data and may be represented as an electronic record that may be referred to as a “merchant management portfolio record” or a “portfolio record”. Accordingly, the merchant analytics computing device processes merchant definitions and any imported user data associated with a plurality of merchants to create a portfolio record.

“Property identifiers” may include known names (or any suitable unique alphanumeric identifier) of commercial real estate assets of which a merchant is a tenant, owner, etc. (e.g., “XYZ Mall”). In an example embodiment, the merchant analytics computing device uses property identifiers to designate a location for each merchant within the portfolio record. As described below, a user may accordingly view and manage individual merchants within a portfolio distinguished by identifiers including property identifiers.

“Property location information” may include any information defining the geographic location of a merchant. In some examples, property location information may include physical addresses, geographic coordinates in latitude and longitude, elevation information (e.g., a floor or floors of a building associated with a commercial real estate asset), and any other suitable information. In some examples, property location information may include boundary information defining a physical area (or areas) containing the merchant. In an example embodiment, property location information may be used by the merchant analytics computing device to identify the merchant graphically (i.e., to provide visually mapped information showing the physical location of the merchant).

“Merchant classification information” includes information categorizing the merchant within categories that may be relevant to the monitoring of the value of the merchant. For example, merchant classification information may categorize a merchant according to a particular industry, location, or other classification, for example, “retail”, “office”, “warehouse”, “manufacturing”, “healthcare,” “outdoor mall”, “indoor mall” and any other suitable information.

The merchant analytics computing device may also generate a unique portfolio identifier in the Setup Phase to identify the portfolio record. Accordingly, a user device (operated by a user) may provide such a portfolio identifier at a later point in time and retrieve the portfolio record to review or monitor portfolio defined by the portfolio record.

In at least some examples, the user data received by the merchant analytics computing device includes a plurality of investment goals associated with each merchant and/or with the portfolio. At least parties associated with the portfolio (e.g., commercial owners or lenders, marketing directors, investors, managers) may have varying financial goals for a portfolio. Because investors and lenders may vary in their underlying interests, the merchant analytics computing device may be configured to monitor merchants pursuant to such investment goals. For example, the merchant analytics computing device may be configured to identify certain merchants meeting or exceeding the investment goals and other merchants not meeting the investment goals, such that the investors may make financial decisions regarding the relative worth or success of the various merchants. The user data may also include various specifications descriptive of existing merchants and/or merchant locations in the portfolio or descriptive of merchants and/or merchant locations outside of the portfolio (in the case of a commercial real estate broker looking to buy, rent, or lease a merchant location).

In one particular example, a business may own, or otherwise be associated with, multiple merchants at multiple merchant locations. A user interested in the marketing money invested in the various merchants (e.g., a marketing director or Chief Marketing Officer) may import investment goals to the merchant analytics computing device that accord with the goals of the business. For example, the user may have a marketing budget of $500 million. The investment goals may prioritize the merchants with the highest growth, such that a higher percentage of the marketing budget may be spent near those merchants. The investment goals may alternatively prioritize merchants with the highest traffic, highest ticket size, or highest stability. Accordingly, as will be described further herein, the merchant analytics computing device may use the investment goals to identify the merchant(s) with the strongest merchant analytics (e.g., highest scores) to the user.

The merchant analytics computing device may calculate and display merchant analytics that include transactions with eating establishments and can also calculate and display merchant analytics that do not includes transactions with eating establishments. In some embodiments, the merchant analytics computing device excludes eating establishments from the calculation of merchant analytics for each sector by default. The merchant analytics calculated and displayed are not based on transactions with eating establishments. These transactions can be excluded by the merchant analytics computing device based on “merchant classification information.” Merchant classification information includes information categorizing the merchant within categories that may be relevant to the monitoring of the value of the merchant. For example, merchant classification information may categorize a merchant according to a particular industry, location, or other classification, for example, “retail”, “office”, “warehouse”, “manufacturing”, “healthcare”, “eating establishment”, “outdoor mall”, “indoor mall” and any other suitable information. In further embodiments, “merchant classification information” includes the type of eating establishment designated, for example, by style of food, cost, etc.

Using the user interface as described herein, a user may select that the merchant analytics computing device include eating establishments in the calculation of merchant analytics for each sector. A user may also select this as the default for the merchant analytics computing device. The merchant analytics computing device includes transactions with eating establishments in the calculation of the merchant analytics. Tip scores are generated for each sector and the composite score for each sector is based, at least in part, on the tip score for the sector.

In further embodiments, a user may select that the merchant analytics computing device only include eating establishments in the calculation of merchant analytics for each sector. The merchant analytics computing device excludes transactions with other types of merchants from the calculation of the merchant analytics for each sector.

### Evaluation Phase

In an example embodiment, the merchant analytics computing device generates analytics (e.g., a score) associated with a merchant or a sector in a process that may be referred to as the “Evaluation Phase”. The merchant analytics computing device is configured to generate the analytics based on received transaction data associated with the merchant or sector. As used herein, “transaction data” may include transaction amounts, merchant identifiers, account identifiers, associated time and date stamps, and data descriptive of the product(s) purchased. Merchant identifiers may include an identifier of the merchant at which the transaction was initiated as well as an identifier of the physical location (e.g., a street address, geographic coordinates, etc.) of the merchant. In the example embodiment, the merchant analytics computing device receives transaction data from a payment processor integral to or associated with a payment processing network. In some embodiments, the transaction data is anonymized and aggregated by merchant prior to receipt by the merchant analytics computing device (i.e., no personally identifiable information (PII) is received by the merchant analytics computing device). In other embodiments, the merchant analytics computing device may be configured to receive transaction data that is not yet anonymized and/or aggregated, and thus may be configured to anonymize and aggregate the transaction data. In such embodiments, any PII received by the merchant analytics computing device is received and processed in an encrypted format, or is received with the consent of the individual with which the PII is associated. In situations in which the systems discussed herein collect personal information about individuals including cardholders or merchants, or may make use of such personal information, the individuals may be provided with an opportunity to control whether such information is collected or to control whether and/or how such information is used. In addition, certain data may be processed in one or more ways before it is stored or used, so that personally identifiable information is removed.

The merchant analytics computing device may generate multiple merchant analytics for each merchant and may generate “aggregated merchant analytics” for each sector. Aggregated merchant analytics refer generally to an average, weighted average, or any other aggregation of individual merchant analytics generated for merchants located in the sector. For example, the “merchant analytics” may include at least one of a growth score, a stability score, a size score, a ticket size score, a traffic score, a tip size score, and a composite score for each sector. A “growth score” is a ranking of the growth of the sector relative to other sectors in the geographic region, wherein “growth” refers generally to sales revenue growth over a period of time. A “stability score” is a ranking of the stability of the sector, wherein “stability” refers generally to a maintenance of sales revenue within a range of sales revenues around an average. A “size score” is a ranking of the size of the sector, wherein “size” refers generally to total sales revenue. A “traffic score” is a ranking of the traffic of the sector, wherein “traffic” refers generally to a number of monthly transactions. A “ticket size score” is a ranking of the ticket size of the sector, wherein “ticket size” refers generally to a transaction amount, and may be calculated by dividing the size by the traffic (i.e., dividing sales revenue by the number of transactions). A “tip size” score is a ranking of the tip size of eating establishments within the sectors, wherein “tip size” refers generally to an amount of tip or gratuity added to a transaction amount. A “composite score” is a composite of the previous five scores (growth, stability, size, traffic, and ticket size), to provide an overall ranking of the sector. In some embodiments, the merchant analytics computing device may generate a “sub-composite score.” A sub-composite score is a composite of the ticket size score and the tip size score. For example, the sub-composite score is an average of the ticket size score and the tip size score, a weighted average of the ticket size score and the tip size score, and/or otherwise a composite of the ticket size score and the tip size score. The general term “score” without a modifier is used herein, may refer collectively to any or all of the preceding scores to describe characteristics shared by some or all of the scores. Each of these scores (collectively “analytics”) may be generated for each merchant within a sector and may be subsequently aggregated to generate aggregated merchant analytics for the sector.

In the example embodiment, the score is normalized to be between 0 and 1,000. In some embodiments, a higher score indicates a “better” sector (i.e., a higher relative ranking). For example, a sector with a score of 800 may rank higher on any or all of the above-described factors than a sector with a score of 300. A “Better” sector refers to a sector that is preferred over other sectors (or is performing better) based upon the financial transactions performed at merchants located within that sector.

In the example embodiment, the merchant analytics computing device receives transaction data associated with merchants that spans a period of time. For example, the merchant analytics computing device may receive and process transaction data for a merchant or sector that spans between one month and at least two years prior to the date of receipt. Accordingly, the merchant analytics computing device may generate the analytics as functions of time. For example, a growth score would be meaningless if there were no transaction data for a past date from which to determine relative growth. In the example embodiment, the merchant analytics computing device generates analytics for each merchant and/or sector using 12 months' or one year's worth of transaction data for the merchant and/or sector. Accordingly, a growth score is representative of the growth of the sector over the past year, the stability score is representative of the stability of the sector over the past year, etc. In other embodiments, the merchant analytics computing device may be further configured to determine a “spot” score of any of the above-described scores, wherein a “spot” score refers generally to a score calculated for a shorter period of time, for example, three months as opposed to twelve months. The spot score may be used to determine changes in the characteristics of the merchant over a short period of time that may be masked or hidden when scoring the merchant over a year. For example, if a merchant debuted a new, highly anticipated product two months ago, a dramatic increase in sales growth over those two months may be dulled by looking at the full year's growth. As another example, if a sector (e.g., a particular city neighborhood) enacted multiple marketing campaigns over the course of a year, it may be difficult to determine which particular campaign was the most effective in increasing traffic, if the entire year's worth of transaction data is used to score the sector.

In one embodiment, the merchant analytics computing device may determine a growth score for a merchant using the received transaction data over a period of time (e.g., a year). The merchant analytics computing device determines the increase or decrease in the sales revenue for the merchant over that year based on the aggregation of all of the transaction data associated with the merchant. Additionally or alternatively, the growth for a merchant may be calculated by fitting total sales revenue to a regression line and tracking resulting slopes. Additionally or alternatively, quarterly sales revenue (i.e., 3-months' worth of sales revenue data) may be calculated and compared to the corresponding quarter of the previous year. As the growth score is a relative ranking, the merchant analytics computing device may compare the determined growth of each merchant prior to providing the numerical growth score for each merchant. The merchant analytics computing device may then use the growth scores of all of the merchants in a sector to determine an aggregated growth score for the sector (e.g., an average or weighted average of the merchant growth scores for the merchants within the sector). Alternatively, the merchant analytics computing device may use the determined growth of each merchant in a sector to determine an aggregated growth score for the sector and may subsequently compare sectors. The merchant analytics computing device may then provide the (numerical) growth score for the sector.

In one embodiment, the merchant analytics computing device may determine a stability score for a merchant using the received transaction data over a period of time (e.g., a year). The stability of a merchant is a metric or analytic of the volatility of the merchant's cash flow. The merchant analytics computing device may determine an average sales revenue for the merchant over a year or may receive an average sales revenue for the merchant (which may be an “expected” average sales revenue or other value received from a user associated with the merchant or may be retrieved from a database). The merchant analytics computing device may then determine a range around that average (e.g., one standard deviation, a certain percentage or fraction of the average, or any other suitable range) which indicates stable sales revenue. Using aggregated transaction data, the merchant analytics computing device identifies whether the merchant had sales revenue within that range. Falling outside of the range indicates less stable sales revenue and lowers the ranking of the merchant in terms of stability. The merchant analytics computing device may use monthly transaction data to determine, at each month, whether the merchant had sales revenue within the predetermined range. Alternatively, the merchant analytics computing device may use transaction data from any other interval (i.e., each week, every two weeks, over the year, etc.) to determine the stability of the sales revenue of the merchant. As the stability score is a relative ranking, the merchant analytics computing device may compare the determined stability of each merchant prior to providing the numerical stability score for each merchant. The merchant analytics computing device may then use the stability scores of all of the merchants in a sector to determine an aggregated stability score for the sector (e.g., an average or weighted average of the merchant stability scores for the merchants within the sector). Alternatively, the merchant analytics computing device may use the determined stability of each merchant in a sector to determine an aggregated stability score for the sector and may subsequently compare sectors. The merchant analytics computing device may then provide the (numerical) stability score for the sector.

In one embodiment, the merchant analytics computing device may determine a size score for a merchant using the received transaction data associated with the merchant over a period of time (e.g., a year). The size metric or analytic may be considered a proxy analytic for how large a particular merchant or business is. The merchant analytics computing device may aggregate the total sales revenue for the merchant for each month in the year, or over the whole year. As the size score is a relative ranking, the merchant analytics computing device may compare the determined size of each merchant prior to providing the numerical size score for each merchant. The merchant analytics computing device may then use the size scores of all of the merchants in a sector to determine an aggregated size score for the sector (e.g., an average or weighted average of the merchant size scores for the merchants within the sector). Alternatively, the merchant analytics computing device may use the determined size of each merchant in a sector to determine an aggregated size score for the sector and may subsequently compare sectors. The merchant analytics computing device may then provide the (numerical) size score for the sector.

In one embodiment, the merchant analytics computing device may determine the traffic score for a merchant using the received transaction data over a period of time (e.g., a year). The merchant analytics computing device may identify a number of transactions completed at the merchant for the entire year to determine the traffic for the merchant, or may identify the number of transactions for each month in the year. Additionally or alternatively, other data may be used to determine the traffic at a merchant, including mobile device signal data, as described in co-owned U.S. patent application Ser. No. 14/708,020, the contents of which are hereby incorporated by reference. As the traffic score is a relative ranking, the merchant analytics computing device may compare the determined traffic of each merchant prior to providing the numerical traffic score for each merchant. The merchant analytics computing device may then use the traffic scores of all of the merchants in a sector to determine an aggregated traffic score for the sector (e.g., an average or weighted average of the merchant traffic scores for the merchants within the sector). Alternatively, the merchant analytics computing device may use the determined traffic of each merchant in a sector to determine an aggregated traffic score for the sector and may subsequently compare sectors. The merchant analytics computing device may then provide the (numerical) traffic score for the sector.

In one embodiment, the merchant analytics computing device may determine a ticket size score for a merchant using the received transaction data over a period of time (e.g., a year) and/or using the determined size and traffic for the merchant. The ticket size (also referred to herein as an “average ticket size”) enables improved visibility into the types of merchant in a sector. A low average ticket size, for example, around $5, may indicate a sector includes restaurants or coffee shops. A higher average ticket size, for example, around $2,000, may indicate a sector includes jewelry stores, electronics merchants, or furniture stores. The merchant analytics computing device may calculate the ticket size for the merchant by dividing a sales revenue of the merchant by a number of transactions. Alternatively, the merchant analytics computing device may calculate the ticket size by dividing a size of the merchant as determined above, by a traffic of the merchant, as determined above. As the ticket size score is a relative ranking, the merchant analytics computing device may compare the determined ticket size of each merchant prior to providing the numerical ticket size score for each merchant. The merchant analytics computing device may then use the ticket size scores of all of the merchants in a sector to determine an aggregated ticket size score for the sector (e.g., an average or weighted average of the merchant ticket size scores for the merchants within the sector). Alternatively, the merchant analytics computing device may use the determined ticket size of each merchant in a sector to determine an aggregated ticket size score for the sector and may subsequently compare sectors. The merchant analytics computing device may then provide the (numerical) ticket size score for the sector.

In one embodiment, the merchant analytics computing device may determine a tip size score for a merchant using transaction data including authorization data and clearing data. Because the clearing data and the authorization data contain two different price amounts, the merchant analytics computing device able to determine the amount of tip that was added. For example, the initial authorization data may contain the base price for food at a restaurant (or other merchant) which may be twenty dollars. Accordingly, the initial authorization data will include a charge of twenty dollars. If a customer subsequently adds a five dollar tip, the clearing data will indicate a final settlement amount including an additional five dollars that has been added, for a total amount of twenty-five dollars. Accordingly, the merchant analytics computing device may determine that a five dollar tip has been added to a twenty dollar base price by comparing the clearing data and the authorization data. With this information, the merchant analytics computing device may determine not only the tip amount, but also a percentage of the tip with respect to the base price, which in this example is twenty five percent ($5/$20).

In order to generate gratuity information about tips left by consumers based on location, the merchant analytics computing device may query a database such as an authorization database of a data warehousing system of a merchant analytics computing device in order to retrieve authorization data relating to transactions carried out at one or more merchants in a given time period. Respective authorizations included in the authorization data may include a first set of transaction identifiers (e.g., an account number, a card number, a primary account number, a time and date of the transaction, a location, a merchant identification, a merchant category code, etc.), and an authorized transaction amount, as well as other data. Similarly, the merchant analytics computing device may query a clearing database of a data warehousing system in order to retrieve clearing data for the same time period as the retrieved authorization data. Here, respective clearings included in the clearing data may include a second set of transaction identifiers, a clearing transaction amount, as well as other data. In alternative embodiments, the transaction data including authorization data and clearing data is retrieved and/or stored by the merchant analytics computing device as described elsewhere herein.

For example, the merchant analytics computing device may match the first set of transaction identifiers of an authorization to the second set of transaction identifiers of a clearing, for a plurality of transactions, to generate a table of matched identifiers. Based on the table of matched identifiers, the merchant analytics computing device may determine differences between a clearing transaction amount and a corresponding authorization transaction amount for each of a plurality of transactions. The difference in payment amount between a clearing and an authorization is the gratuity paid by a cardholder for a respective transaction. Accordingly, a plurality of gratuities may be stored together with the matched identifiers as well as other relevant transaction details such as merchant identifier, payment card identifier, location, time and date, in a gratuity database of the merchant analytics computing device. For example, the clearing transaction may be represented by a clearing message, and the authorization transaction may be represented by an authorization message.

The stored gratuities may be used by the merchant analytics computing device to determine various aggregate quantities which may depend on one or more of the merchant identifier, location, payment card identifier, time of day, day of week, and month of year, for example. An “aggregate quantity”, as used herein, may refer to one or more summary statistics, including (without limitation) measures of location, dispersion, or statistical dependence. For example, an aggregate may be a mean of a set of values (e.g. a mean gratuity amount), or a more robust measure of location such as a median, trimmed mean, or Winsorized mean. An aggregate may also be a measure of dispersion such as a standard deviation, median absolute deviation, or interquartile range. The merchant analytics computing device uses the stored gratuities and/or the aggregate quantity to calculate the tip size score for the merchant and/or sectors. In one embodiment, the tip size score is determined by calculating the average gratuity for each transaction with a particular eating establishment merchant within a sector. This is repeated for each merchant within the sector and the average tip sizes for each merchant in the sector are averaged to determine an average gratuity for the sector. This is normalized against other sectors to determine the tip size score for the sector.

According to various examples, the merchant analytics computing device may compute an average or median gratuity amount (e.g., average gratuity per transaction or average percentage of transaction authorization amount) for respective merchants, using the merchant identifier field of the authorization data. The average or median gratuity amount for each merchant may be stored in the gratuity database and may be updated at regular intervals as further transactions are received. Similar computations may be made by the merchant analytics computing device for other variables such as merchant type (e.g., restaurant, bar or pub, taxi, hotel, etc.), location (e.g., city, suburb or state), time of day (e.g., 12 pm-3 pm and 6 pm-9 pm), or combinations of these. In addition, the authorization data and/or the clearing data may include a merchant identification as well as a geographic location of the merchant. Location information may also be stored by the merchant analytics computing device. Accordingly, the merchant analytics computing device may group together tipping data of a group of similar types of businesses (i.e., an aggregate) based on location, for example, barber shops, Chinese restaurants, taxi cab companies, golf courses, and the like.

In one embodiment, the merchant analytics computing device may determine a composite score for a merchant based on the growth, stability, size, traffic, and/or ticket size score for the merchant. The composite score may be an average of all five scores, may be a weighted average of all five scores, or may be any other combination or aggregation of the five scores for the merchant location. The composite score for a sector may be an average of all five scores, may be a weighted average of all five scores, or may be any other combination or aggregation of the five scores for the sector (e.g., an average or weighted average of the merchant composite scores for the merchants within the sector). Alternatively, the composite score for a sector may be an average, weighted average, or any other aggregation of the composite scores of the merchants in the sector. The composite score is intended to be an “at-a-glance” ranking of the relative success of the sector, taken as a function of the five identified characteristics that may reflect the success of a business.

In one embodiment, the merchant analytics computing device may determine a sub-composite. The merchant analytics computing device may determine a sub-composite score for an eating establishment based on the ticket size score and tip size score for the merchant. The sub-composite score may be an average of the two scores, may be a weighted average of the two scores, or many be any other combination or aggregation of the two scores for the eating establishment. The sub-composite score for a sector may be an average of the two scores for the sector, may be a weighted average of the two scores for the sector, or may be any other combination or aggregation of the two scores for the sector (e.g., an average or weighted average of the merchant composite scores for the eating establishments within the sector). Alternatively, the sub-composite score for a sector may be an average, weighted average, or any other aggregation of the sub-composite scores of all of the eating establishments in the sector. The sub-composite score may provide a better indication of the “caliber” of a sector as the sub-composite score may be a better reflection whether a sector includes of high-end restaurants vs. family-style restaurants.

In some embodiments, the merchant analytics computing device may be configured to generate and store merchant analytics for a merchant and/or a sector over multiple periods of time. For example, the merchant analytics computing device may initially generate a score based on data having timestamps from Jun. 1, 2013-Jun. 1, 2014 and may store that score as Score 1. The merchant analytics computing device may then generate a score based on data having timestamps from Jul. 1, 2013-Jul. 1, 2014, and may store that score as Score 2. The merchant analytics computing device may store N scores (or any other analytics) for a merchant and/or a sector, wherein N is an integer greater than one. Accordingly, the merchant analytics computing device may store a time series of scores (or any other analytics) for a merchant and/or a sector, which collects all N scores for the merchant and/or the sector sequentially (i.e., in order of time, from oldest to newest).

In one embodiment, the merchant analytics computing device may update a portfolio record with any or all of the analytics for a merchant and/or any or all aggregated merchant analytics for a sector in which the merchant is located. The merchant analytics computing device may be configured to determine analytics for the portfolio as a whole, using the generated analytics for each merchant in the portfolio and/or each corresponding sector. The merchant analytics computing device may be further configured to sort the merchants in a portfolio based on the investment goals for the portfolio. For example, if an investment goal identifies growth as a priority, the merchant analytics computing device may sort the merchant records in the portfolio record according to highest growth score. If there are no investment goals or if there are conflicting investment goals, the merchant analytics computing device may sort the merchant records in the portfolio according to highest composite score.

### Optimization Phase

The system is also configured to facilitate optimization of portfolios in an “Optimization Phase.” In one example, the system is configured to sort the merchant records in the portfolio according to the investment goals of a user. As described briefly above, some users may be responsible for or otherwise interested in a distribution of a marketing budget according to the investment goals, in some cases prioritizing growth or traffic or stability, as desired. If the user (a CMO, in this example, for illustrative purposes only) has a specific, predetermined budget and predetermined investment goals, the system may enable the CMO to distribute the budget based on the evaluation of all of the merchants in the CMO's portfolio. If, for example, the CMO chose to prioritize growth in his/her investment goals for his/her associated business, the system may sort the merchant location records in the portfolio from highest growth score to lowest growth score and may present the results as a list. In some implementations, the CMO may import more specific investment goals to the system. For example, the CMO may indicate that 15% of his/her budget is to be spent on the top 5% of merchants in the portfolio with the highest growth. The next 15% is to be spent on the 10% of merchants with the next-highest growth. The next 10% is to be spent on the 10% of the merchants with the next-highest growth, and so on and so forth. The system may use these specific investment goals and output an optimized portfolio record that divides the merchant records into the desired percentiles.

In another example, the system is configured to provide recommendations for new locations for merchants using existing merchant records in a portfolio. In this example, a user (a real estate broker, for illustrative purposes only) may have received an offer from a merchant to rent (or lease) a merchant location (e.g., a property or a portion of a property). The merchant may have a particular sector in mind, or may have indicated in the offer that he/she desires a merchant location having certain specifications (e.g., a merchant location in a high-traffic sector). The real estate broker may import the specifications into the system, which may output an optimized portfolio to the real estate broker including sector records of sectors including available merchant locations having the specifications. Alternatively, the real estate broker may use the system to locate and/or suggest a sector other than the particular sector identified in the offer, by illustrating (using a user interface provided by the system) higher performance (e.g., higher traffic or higher growth) in a different sector. In another related example, the real estate broker may have an existing client complaining of poor performance at his/her merchant location. The real estate broker may illustrate (using the user interface provided by the system) slowing growth or traffic trends in the client's current sector, and may suggest relocation to a sector with higher recent performance.

### User Interface

The merchant analytics computing device is further configured to facilitate the display of an interactive graphical user interface (UI). The UI may be displayed on a user computing device of a user. The UI is configured such that the user may easily view aggregated merchant analytics for a sector and/or for a particular industry, for example, as a graphical representation displayed on a map. In one embodiment, the UI is populated with data that is updated on a monthly basis, however, in other embodiments, the UI may be populated with data updated at any other interval (e.g., weekly, daily, etc.).

In the example embodiment, the user may search by location to find a geographic region (e.g., state, city, zip code, zip+4, county, neighborhood) in which the user is interested. The UI displays the geographic location divided into defined sectors. In some embodiments, the UI enables a user to “zoom in” and “zoom out” on the view. Zooming in may provide a view of the sectors at a more granular level. Zooming out may provide a view of sectors aggregated into larger geographic regions, for example, by city, county, or state. In the example embodiment, displayed sectors are colored or shaded according to the strength of generated merchant analytics, wherein a darker or more saturated color or shade indicates stronger analytics (e.g., more successful sectors). Accordingly, the user may easily discern sectors with stronger analytics, with only a single glance. In other embodiments, lighter colors may indicate stronger analytics. In still other embodiments, the sectors may not be colored or shaded at all.

As will be described further herein, the UI may provide to user an option to view sectors according to different metrics (e.g., according to the various scores described above included within the merchant analytics). The UI may also allow the user to switch between a “street map” view, in which the divisions of defined sectors are overlaid upon a traditional street map, and a “satellite view”, in which the defined sectors are overlaid upon satellite imagery of the geographic region. Accordingly, depending on the view, users may be able to more easily understand the delineations between sectors and the geographical advantages that may serve certain sectors over others. In addition, as will be described further herein, the UI may provide other tools to the user for navigation of the merchant analytics and for a “deeper dive” into the granularity of the analytics.

As one example, a user such as a consumer is interested in dining at a high-end eating establishment. That user may select the tip size or sub-composite score metric and find a nearby sector most likely to include a plurality of high-end restaurants. As another example, a user such as a merchant is interested in locating their business in a sector with affluent clientele (e.g., another high-end restaurant merchant or a merchant selling goods or services marketed towards affluent consumers, such as jewelry). That user may also select the tip size or sub-composite score metric and find a sector most likely to include high-end eating establishments, and therefore likely to include and/or cater to more affluent consumers.

Furthermore, a user such as a merchant or business owner can use the tip size score and/or other merchant analytics about particular sectors to facilitate determinations about the location in which to open an eating establishment, close an eating establishment, remodel an eating establishment, or otherwise manage one or more eating establishments. For example, a user may select a sector that has a high tip size score in which to open a new fine dining eating establishment or other eating establishment with lower transaction volume and higher average tickets. A user may select a sector with a lower tip size score in which to open an eating establishment such as a family style restaurant, fast food restaurant, or the like. Similarly, a user can use tip size scores and/or other merchant analytics for managing other businesses that involve the receipt of gratuities.

Through the monitoring of commercial real estate portfolios, the systems and methods are further configured to facilitate (a) integration of transaction data into the generation of merchant analytics by linking transaction data received from interchange networks (or payment networks) to such analytics, (b) improvement of the visualization of sector value or success, relative to other sectors and over time, and (c) optimization of investment by using objective evaluations of relative success of certain sectors and/or merchants over others.

The technical effects of the systems and methods described herein can be achieved by performing at least one of the following steps: (i) defining a plurality of sectors of a geographic region; (ii) receiving transaction data for financial transactions occurring within a period of time, the transaction data associated with a plurality of merchants, the plurality of merchants located in the geographic region, the transaction data including authorization transactions and clearing transactions; (iii) matching, for each merchant of the plurality of merchants, a plurality of authorization transactions with a respective plurality of clearing transactions; (iv) calculating a tip size for each of the plurality of matched transactions; (v) identifying, for each merchant of the plurality of merchants, one sector of the plurality of sectors in which the merchant is located; (vi) generating aggregated merchant analytics for each sector based on the transaction data associated with all merchants of the plurality of merchants located in the sector, wherein the aggregated merchant analytics represent a ranking of each sector relative to all other sectors of the plurality of sectors, the aggregated merchant analytics including at least a tip size score based on the calculated tip size; and (vii) displaying on a user interface of the user computing device the aggregated merchant analytics, wherein the aggregated merchant analytics are graphically represented on a map of the defined sectors.

The following detailed description of the embodiments of the disclosure refers to the accompanying drawings. The same reference numbers in different drawings may identify the same or similar elements. Also, the following detailed description does not limit the claims.

Described herein are computer systems such as merchant analytics computing devices. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the generation and communication (e.g., display) of aggregate merchant valuation analytics.

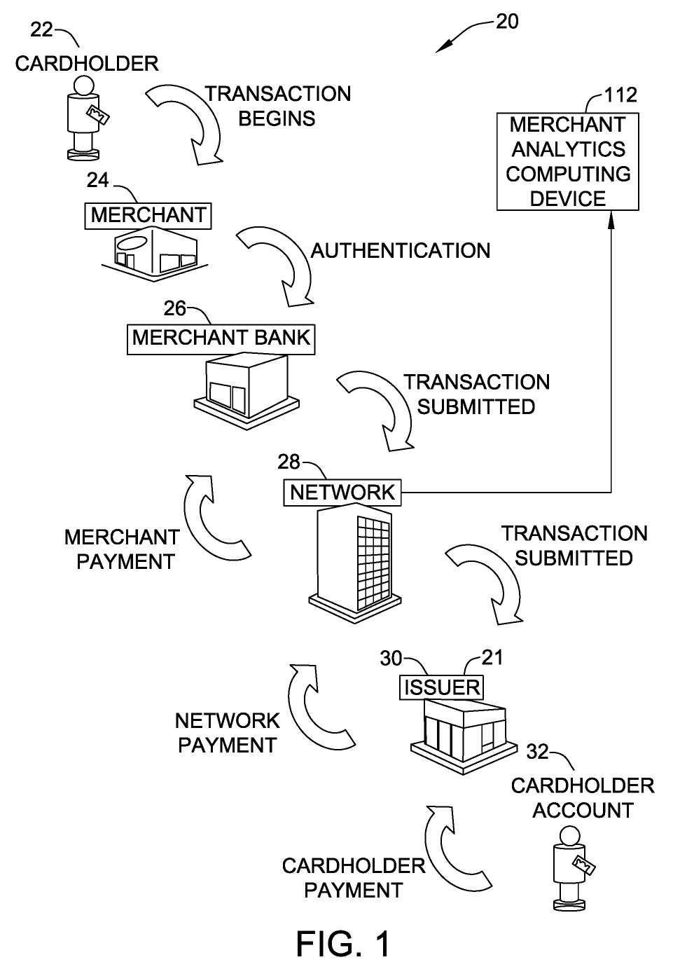

FIG. 1 is a schematic diagram illustrating an example multi-party payment card system 20 for enabling payment-by-card transactions and communicating aggregated merchant analytics for a sector, in accordance with one embodiment of the present disclosure. FIG. 1 depicts a flow of data involving a financial transaction through system 20, which includes a merchant analysis computing device 112. Components of system 20 provide merchant analysis computing device 112 with transaction data, which merchant analysis computing device 112 processes to generate merchant analytics and provide the analytics on a user interface.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions registered with MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

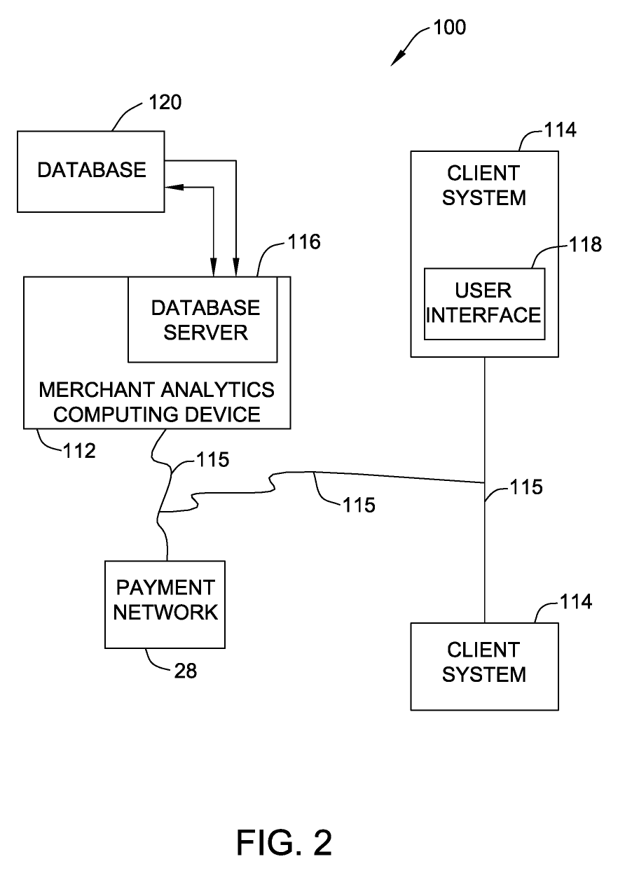

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including merchant analytics computing device 112. In the example embodiment, interchange network 28 provides such transaction data (including merchant data associated with merchant tenants of each commercial real estate asset of each portfolio record) and additional transaction data. In alternative embodiments, any party may provide such data to merchant analytics computing device 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, merchant analytics computing device 112 may be used to generate and communicate aggregated merchant analytics. The systems described herein are not intended to be limited to the described uses. Rather, the uses of the systems described herein are intended as examples and should not be considered limiting.

FIG. 2 is an expanded block diagram of an example embodiment of a computer system 100 used in processing payment transactions that includes merchant analytics computing device 112 in accordance with one example embodiment of the present disclosure. In the example embodiment, system 100 is used for generating merchant analytics and displaying said analytics on a user interface, as described herein.

More specifically, in the example embodiment, system 100 includes a merchant analytics computing device 112, and a plurality of client sub-systems, also referred to as client systems 114, connected to merchant analytics computing device 112. In one embodiment, client systems 114 are computers including a web browser, such that merchant analytics computing device 112 is accessible to client systems 114 using the Internet and/or using network 115. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store data. Merchant analytics computing device 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on merchant analytics computing device 112 and can be accessed by potential users at one of client systems 114 by logging onto merchant analytics computing device 112 through one of client systems 114. In an alternative embodiment, database 120 is stored remotely from merchant analytics computing device 112 and may be non-centralized. Database 120 may be a database configured to store information used by merchant analytics computing device 112 including, for example, transaction data, defined sectors, merchant definitions, user data, portfolio records, merchant scores, and sector scores.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data.

In the example embodiment, one of client systems 114 may be associated with one of acquirer bank 26 (shown in FIG. 1) and issuer bank 30 (also shown in FIG. 1). For example, one of client systems 114 may be a POS device. Client systems 114 may additionally or alternatively be associated with a user (e.g., a commercial real estate owner or lender, a marketing director, a consumer, or any other end user). In the example embodiment, one of client systems 114 includes a user interface 118. For example, user interface 118 may include a graphical user interface with interactive functionality, such that aggregated merchant analytics, transmitted from merchant analytics computing device 112 to client system 114, may be shown in a graphical format. A user of client system 114 may interact with user interface 118 to view, explore, and otherwise interact with the merchant analytics. For example, a user can interact with user interface 118 to interact with merchant analytics data displayed and change the data being presented or displayed. Merchant analytics computing device 112 may be associated with interchange network 28 and/or may process transaction data.

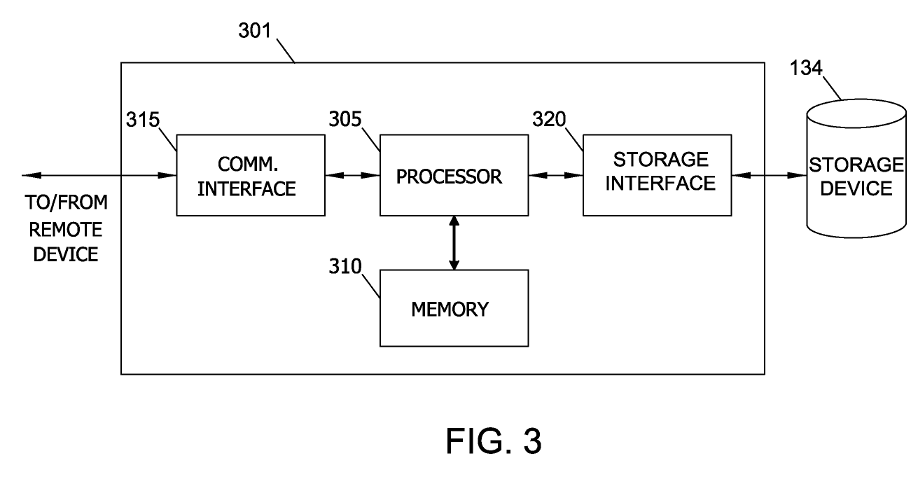

FIG. 3 illustrates an example configuration of a server system 301 such as merchant analytics computing device 112 (shown in FIGS. 2 and 3) used to generate merchant analytics and present said analytics on an interactive user interface, in accordance with one example embodiment of the present disclosure. Server system 301 may also include, but is not limited to, database server 116. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests (e.g., requests to display merchant analytics and/or provide an interactive user interface) from a client system 114 via the Internet, as illustrated in FIG. 2.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

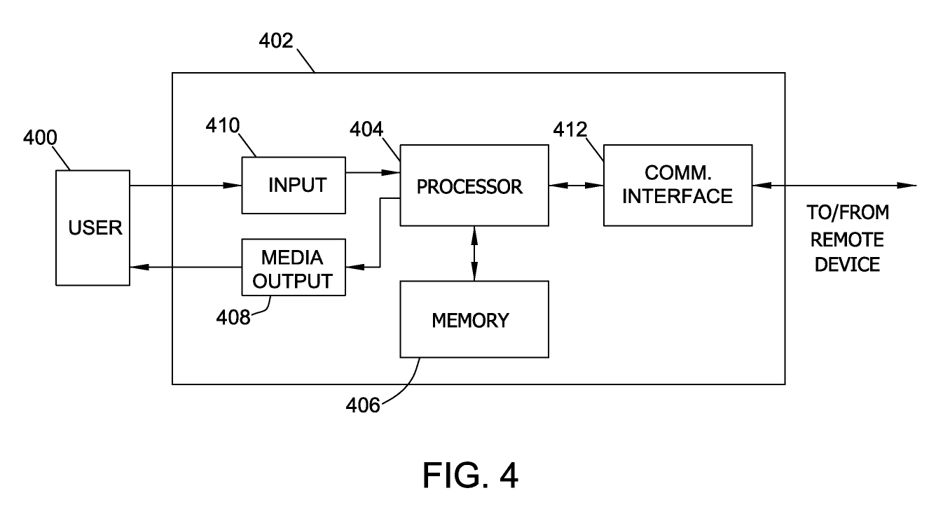

FIG. 4 illustrates an example configuration of a client computing device 402. Client computing device 402 may include, but is not limited to, client systems (“client computing devices”) 114. Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400 (e.g., a cardholder 22). Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 302 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 406 are, for example, computer-readable instructions for providing a user interface to user 400 via media output component 408 and, optionally, receiving and processing input from input device 410. A user interface may include, among other possibilities, a web browser and client application. Web browsers enable users 400 to display and interact with media and other information typically embedded on a web page or a website from a web server associated with a merchant. A client application allows users 400 to interact with a server application associated with, for example, a merchant. The user interface, via one or both of a web browser and a client application, facilitates display of generated merchant analytics by merchant analytics computing device 112. The user may interact with the user interface to view and explore the merchant analytics, for example, by selecting a sector of interest using input device 410 and viewing analytics associated with that sector.

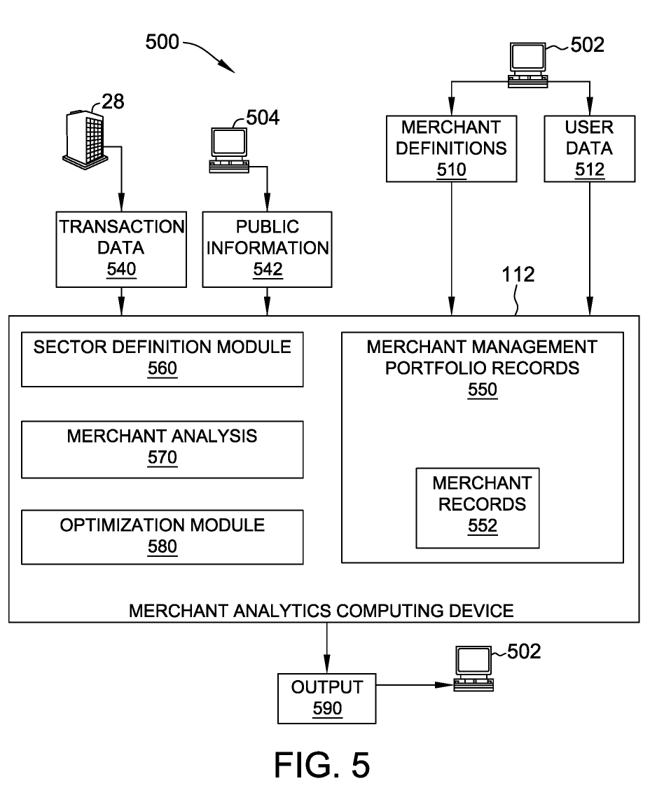

FIG. 5 is a simplified data flow diagram for generating aggregated merchant analytics for a sector, and providing the analytics for display on a user interface using merchant analytics computing device 112. As described herein, merchant analytics computing device 112 receives merchant definitions 510 and user data 512 (such as investment goals) from a user device 502 (such as a commercial lender, a commercial owner, or a marketing director). Merchant analytics computing device 112 defines a plurality of merchant records 552 based on merchant definitions 510 in the Setup Phase as identified above and herein. Merchant analytics computing device 112 further defines merchant management portfolio record 550 based on such merchant definitions 510.

Merchant analytics computing device 112 also receives transaction data 540 associated with a plurality of merchants being analyzed. Transaction data 540 may be received from interchange network 28. Other information including census data or other public information 542 data may be received from external systems such as external server 504.

Merchant analytics computing device 112 includes a plurality of modules 560, 570, and 580 that facilitate generation and display of merchant analytics. Specifically, merchant analytics computing device 112 includes sector definition module 560 configured to define sectors and identify merchants located in each sector, as specified in the Sector Definition Phase. Sector definition module 560 may update merchant records 552 to reflect the sector in which each associated merchant is located. Merchant analytics computing device 112 also includes merchant analysis module 570 configured to generate analytics for each merchant record 552 (or for each sector in which a merchant is located) in merchant management portfolio record 550, as specified in the Evaluation Phase. Merchant analytics computing device 112 also includes optimization module 580 configured to perform optimization tasks for merchant management portfolio record 550 as specified in Optimization Phase.

Merchant analytics computing device 112 is also configured to provide outputs 590 as described herein. Specifically, outputs 590 may include merchant analytics for each merchant for which there is an associated merchant record 552, as well as aggregated merchant analytics for each associated sector. Outputs 590 may also include an optimized portfolio record 550, which may be sorted to identify and emphasize merchants that align with investment goals. Outputs 590 may also include any and all formatted output for display on a user interface of a user computing device (e.g., client system 114, as shown in FIG. 2).

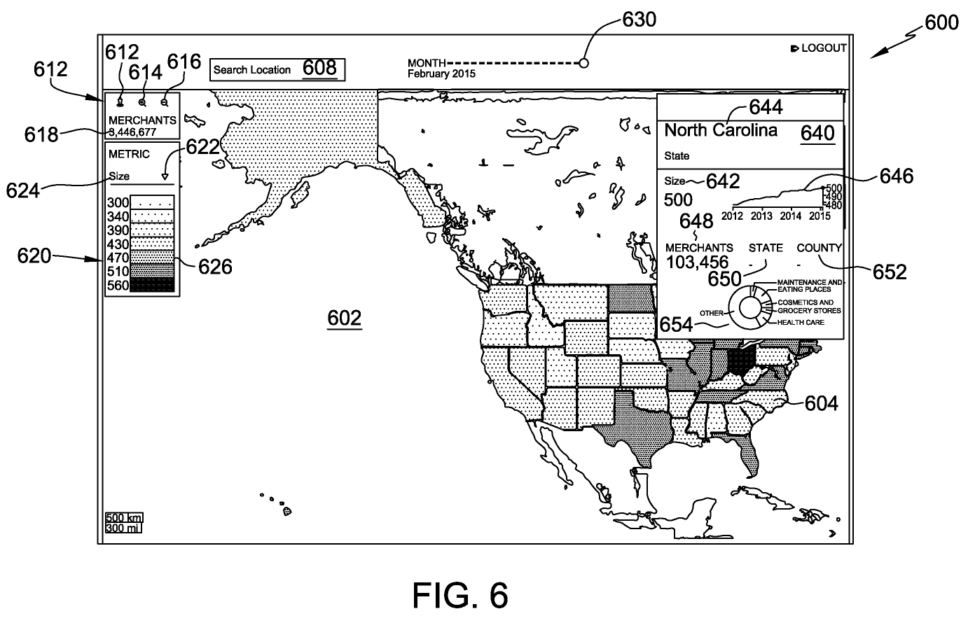

FIGS. 6-15 are example screenshots of a user interface (e.g., user interface 118, shown in FIG. 2) of a user computing device (e.g., client system 114, also shown in FIG. 2). The example screenshots include data generated by merchant analytics computing device 112 (shown in FIG. 2) such as merchant analytics, as described herein. Merchant analytics computing device 112 communicates the merchant analytics to the user device for display on interactive user interface 118.

FIGS. 6-8 are example screenshots of a user interface (e.g., user interface 118, shown in FIG. 2) of a user computing device (e.g., client system 114, also shown in FIG. 2). The example screenshots include data generated by merchant analytics computing device 112 (shown in FIG. 2) such as merchant analytics, as described herein. Merchant analytics computing device 112 communicates the merchant analytics to the user device for display on interactive user interface 118.

More specifically, FIG. 6 depicts a U.S.-level screenshot 600 showing a “zoomed out” view 602 of the United States of America. In view 602, the sectors are defined and displayed at a state-wide level. The screenshot 600 also includes several tools that enable a user to navigate the user interface and to examine the data generated and transmitted by merchant analytics computing device 112. For example, the screenshot 600 depicts a location search bar 608, which enables the user to search for a geographic region of interest. The screenshot 600 also includes a view navigation module 610. The view navigation module 610 includes a “view type” selectable icon 612, which enables the user to toggle between a “street map” view (as shown in view 602) and a “satellite” view (as shown in FIG. 15). The view navigation module 610 also includes “zoom out” 614 and “zoom in” 616 selectable icons. The view navigation module 610 further includes a merchant number indicator 618, which indicates the number of merchants encompassed by the current view (U.S. Pat. No. 3,446,677 in view 602).

The screenshot 600 further includes a metric information module 620. The metric information module 620 allows the user to select between available merchant analytics metrics (e.g., Composite, Sub-composite, Growth, Stability, Size, Traffic, Tip Size, and Ticket Size scores) using a drop-down menu 622. In the example embodiment, the metric information module 620 further includes a score scale 626, which provides an explanation to the user of the color-coding of the sectors. The sectors displayed in view 602 are shown “painted” with colors and/or shades corresponding to the score scale 626, which visually indicates the relative score (for the selected metric 624) for each sector. When a user chooses a different metric using drop-down menu 622, the user interface will “re-paint” (i.e., re-color or re-shade) the displayed sectors (and, in some cases, the score scale 626) to reflect a range of numerical scores according to the selected metric 624. In the example embodiment, a darker color indicates a higher score. In view 602, the selected metric 624 is “Size.” Accordingly, the merchant analytics provided on the user interface are size scores for selected sectors. The screenshot 600 also depicts a time-selection slider 630 that allows a user to advance the display of merchant analytics based on a specific time frame during which the transactions used to determine the merchant analytics occurred.

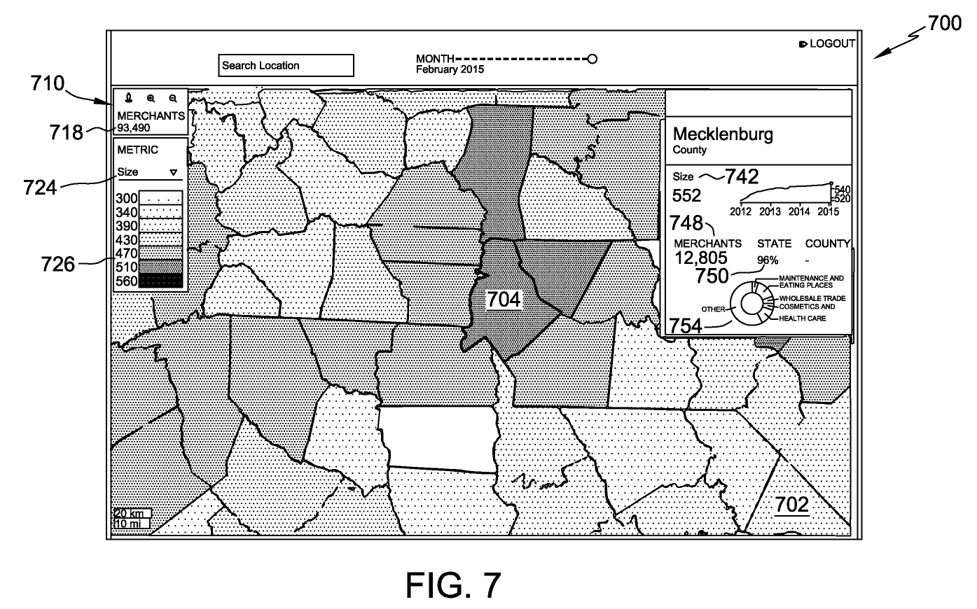

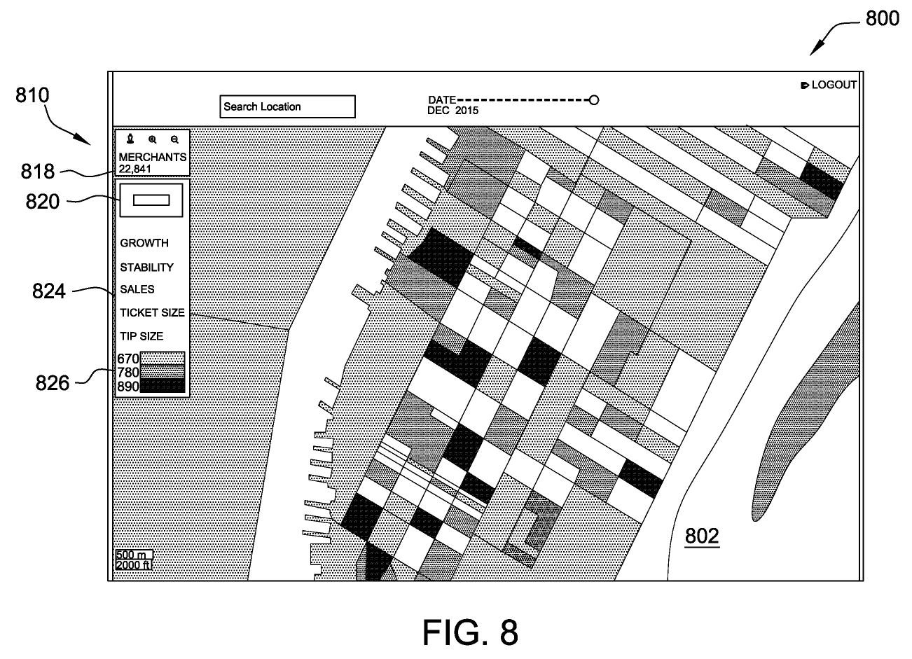

The screenshot 600 also depicts a “smart chart” 640, which provides the user with a score 642 for a selected sector 604, as well as additional information. In view 602, North Carolina is the selected sector 604, as indicated by the sector indicator 644 of the smart chart 640. The smart chart 640 includes, in view 602, a size score 642 for North Carolina (500 in view 602). As view 602 depicts sectors at a state level, the size score 642 for North Carolina is relative to all other states. The smart chart 640 also includes a trend graph 646, which is a visual representation of the size score trends for the selected sector 604 (North Carolina) over time. The smart chart 640 also includes its own merchant number indicator 648, which indicates the number of merchants included in the selected sector 604 (North Carolina). State and County ranking indicators 650, 652 in the current view 602, are blank, as they are not applicable to a state-level sector. State and County ranking indicators 650, 652 will be described further herein with respect to FIGS. 7 and 8. The smart chart 640 also includes an industry chart 654 (a pie chart in the illustrated embodiment), which indicates the percentage of merchant locations in the selected sector 604 associated with various industries.

FIG. 7 depicts a screenshot 700 showing a state-level view 702 (zoomed-in relative to view 602, shown in FIG. 6). View 702 depicts the state of North Carolina divided into county-level sectors. Notably, the merchant number indicator 718 in the view navigation module 710 has changed (relative to the merchant number indicator 618 in FIG. 6), depicting 93,490 merchants encompassed by view 702. The score scale 726 has also changed (relative to score scale 626 in FIG. 6), such that the colors or shades indicate different ranges of scores.

In view 702, Mecklenburg County is the selected sector 704. Accordingly, the information in the smart chart 740 has changed to reflect the data representing Mecklenburg County. For example, the size score 742 is 552, the merchant number indicator 748 reflects a much smaller number of merchants encompassed, and the industry chart 754 has also been updated. The state ranking indicator 750 is now populated. The state ranking indicator 750 denotes the percentile of the selected sector 704 relative to all other sectors in the state. In view 702, the state ranking indicator 750 reads 96%, denoting that Mecklenburg County is in the 96^{th} percentile of counties in the state, according to the selected metric 724 of “size.” The county ranking indicator denotes the percentile of the selected sector relative to all sectors in the county.

FIG. 8 depicts a screenshot 800 showing a view 802 of a plurality of sectors shaded according to corresponding scores. The scores include tip size score and a composite score based, at least in part, on tip size scores. Notably, the merchant number indicator 818 in the view navigation module 810 has changed. Furthermore, the score scale 726 has also changed. In this embodiment, view navigation module 710 includes metrics 824 including composite score, growth score, stability score, traffic (e.g., “sales” score), ticket size score, and tip size score. In further embodiments, metrics 824 include the sub-composite score. View 802, including tip size score and sub-composite score metrics 824, is displayed, for example, when a user selects an eating/restaurant category for which to view merchant analytics. In alternative embodiments, these metrics are automatically present and included in the merchant analytics for all merchant types. Notably, the ticket size score or tip size score may be insufficient by itself to allow a user to determine details about whether a merchant or sector is or includes high end restaurants or family style restaurants (e.g., with a larger number of consumers per ticket). The sub-composite score, based at least in part on the ticket size score and the tip size score, allows users to determine these patterns (e.g., details about the type of eating establish category a merchant or sector falls within).

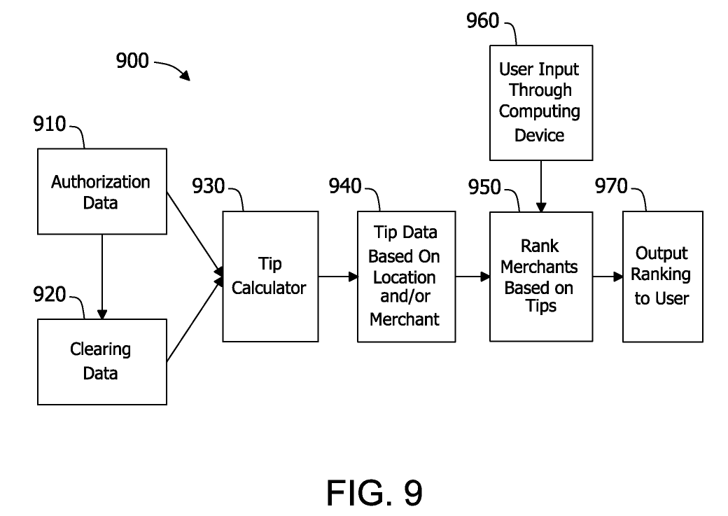

FIG. 9 is a data flow block diagram illustrating an example of a process of calculating and analyzing gratuity data in accordance with an example embodiment. In one embodiment, the merchant analytics computing device may determine a tip size score from a merchant using the received transaction data over a period of time (e.g., a year). The merchant analytics computing device calculates a tip amount for each transaction initiated at the merchant using authorization data and clearing data. In order to pay for a bill at an eating establishment, a customer may provide their account information, for example, a payment card account associated with a payment card such as a credit card or a debit card. An employee, in this example, the waiter or waitress, may input the customer's account information by swiping (or otherwise communicating) a payment card through a point-of-sale (POS) device. The input account information may be transmitted to, for example, a payment processor, an issuing bank, and the like, to authorize payment of the bill for the meal. This initial input includes authorization data of a purchase of a meal, and typically includes the base price of the meal. Upon successful authorization of the base price by the issuing bank, a receipt may be printed out or some other form of confirmation may be generated. In this example, the customer may add a gratuity to the base price by inserting the gratuity into the receipt or confirmation. That is, after the initial authorization for the base price of the meal, the customer has the opportunity to add a gratuity. When the customer adds a gratuity and adds their signature to or otherwise authorizes the final bill, the employee will typically enter the total payment amount or the total amount may be automatically entered. Here, the total amount includes the tip plus the base price. In this example, the total amount may also be sent to the payment processor as a final amount. For example, a clearing message or clearing data including the final total may be transmitted to the payment processor. The merchant analytics computing device may receive both authorization data and clearing data from the payment processor. The merchant analytics computing device may determine that the authorization data for the base price of the meal and the clearing data for the total amount of the meal (i.e., base price plus tip) correspond to the same transaction. For example, the merchant analytics computing device may perform a clearing/authorization matching process that links together authorizations with respective clearings based on one or more transaction identifiers included in the authorizations and the clearings. Accordingly, the merchant analytics computing device may determine that authorization data matches or corresponds to clearing data, and further compare an authorization transaction amount included in the authorization data with a clearing transaction amount included in the clearing data to determine a tip amount.

The merchant analytics computing device may calculate an average, median, and/or other aggregated or collective tip size for the merchant. As the tip size score is a relative ranking, the merchant analytics computing device may compare the determined tip size of each merchant prior to providing the numerical tip size score for each merchant. The merchant analytics computing device may then use the tip size scores of all of the merchants in a sector to determine an aggregated tip size score for the sector (e.g., an average or weighted average of the merchant tip size scores for the merchants within the sector). Alternatively, the merchant analytics computing device may use the determined tip size of each merchant in a sector to determine an aggregated tip size score for the sector and may subsequently compare sectors. The merchant analytics computing device may then provide the (numerical) tip size score for the sector.

Process 900 may analyze transaction data over a period of time, and determine gratuity information based on the transaction data over the period of time. For example, the transaction may be a purchase made using a payment card, for example, a credit card, a debit card, a prepaid card, a charge card, a membership card, a promotional card, a frequent flyer card, an identification card, a gift card, and/or any other device that may hold payment account information, such as a mobile phone, a fob, and the like. Also, the period of time may be any desired amount of time, for example, a week, a month, a year, two years, and the like. In addition, the period of time is not necessarily the most recent period of time but may be, for example, a period of time from a previous month, a previous year, a previous two years, and the like.

In this example, authorization data is generated at block 910. Authorization is the process of approving or declining a transaction before a purchase is finalized or cash is disbursed. For example, the authorization data may be based on a purchase of items such as goods and/or services from a merchant. As a non-limiting example, the items may include a round of golf, a meal at a restaurant, a cab ride, a service provided by a moving company, a barber shop, a hair salon, a cleaning service, and the like. In this example, the authorization data includes one or more transaction identifiers about the transaction which may include an account number or a card number, a time and date of the transaction, a location, a merchant identification, a merchant category code, and the like. The authorization data may be generated in response to an employee of the merchant entering payment information such as the payment card or payment account information of a purchaser. The authorization data may be stored in a database. for example, a data warehousing system of a payment processor.

At block 920, clearing data is generated. Clearing includes the process of exchanging transaction data between a payment processor and an issuing bank (i.e., issuer). From the information provided in clearing, a payment processor may calculate the amounts for settlement. Clearing includes sending transactions from the processor to the issuer for posting to the cardholder's account (also known as “presentment”). The payment processor gathers the information, edits it, assesses the appropriate fees, and sends it on to the appropriate receiver. The clearing messages contain data but do not actually exchange or transfer funds. Like the authorization data, the clearing data also includes one or more transaction identifiers. Also, the clearing data may be stored in a database such as the data warehousing system of the payment processor.

Based on the authorization data and the clearing data, gratuity information may be calculated at block 930. For example, a payment processor may query a database such as an authorization storage and a clearing storage of the data warehousing system to retrieve authorization data and clearing data relating to transactions carried out at one or more merchants at one or more locations in a given time period, for example during the past month, during a past year, during a previous month, during a previous year, and the like. The payment processor may match the transaction identifiers of the authorization data to the transaction identifiers of the clearing data to generate a table of matched identifiers. Based on the table of matched authorizations and clearings, the payment processor may determine gratuities paid by cardholders for the respective transactions, for example, based on a difference in payment amount between the clearing data and the authorization data of a corresponding transaction. The payment processor may determine gratuities for a number of transactions based on purchases by a number of different users. The gratuity information may be stored by the payment processor.

In block 940, the payment processor may determine average gratuity information for a specific merchant or for a group of merchants of the same type within a similar location. For example, the payment processor may calculate the gratuities left by cardholders at a particular merchant over a particular amount of time, for example, a burger restaurant over the past month. In this example, the payment processor may determine an average gratuity left by cardholders at the burger restaurant over the last month and generate tip data. For example, the tip data may include a tip percentage, a tip amount, a current tipping trend for the business, and the like. The current tipping trend may be calculated by comparing historical tipping data with current tipping data and determining a trend based on the comparison.

As another example, the payment processor may group together similar types of merchants located in the same area, and determine average gratuity information for the group of merchants of the same type within the similar location. For example, the payment processor may group together a plurality of burger restaurants included in a particular zip code, and calculate average gratuity data of the plurality of burger restaurants based on calculated gratuities at the burger restaurants in the particular zip code instead of calculated gratuities at an individual burger restaurant. In this example, the gratuity information from a plurality of merchants is aggregated together and may provide an average gratuity of that type of merchant in a particular location.

In block 950, merchants or groups of merchants are compared with each other and a ranking is provided at block 970. In this example, the ranking determined at block 950 and provided at block 970 may be based on and/or in response to an input of a user at block 960. Here, at block 960 the user may determine whether to be provided with tip data of individual merchants or groups of merchants. For example, the user may input one or more locations, a merchant type, and or other information.

For example, at block 950, individual merchants located in a similar location may be compared with each other and a ranking of the merchants based on tip data may be provided at block 970. This information may be helpful to someone looking for employment in a particular area. As another example, tip data of similar merchant types at the same location may be grouped together, and tip data of groups of similar types of merchants from different locations may be compared with each other at block 950 and provided to the user at block 970. This information may be helpful to someone interested in opening a business of a same or similar type of business provided by the grouped merchants.

As described above and herein, in some embodiments, the system and/or components thereof may store merchant identifiers and/or associated payment amounts, gratuity amounts, base price amounts, and total amounts, and/or cardholder/account identifiers, without including sensitive personal information, also known as personally identifiable information or PII, in order to ensure the privacy of individuals and/or merchants associated with the stored data. Personally identifiable information may include any information capable of identifying an individual. For privacy and security reasons, personally identifiable information may be withheld and only secondary identifiers may be used. For example, data received by the system and/or components thereof may identify user “John Smith” as user “ZYX123” without any method of determining the actual name of user “ZYX123”. In some examples where privacy and security can otherwise be ensured (e.g., via encryption and storage security), or where individuals consent, personally identifiable information may be received and used by the system. In situations in which the systems discussed herein collect personal information about individuals and/or merchants, or may make use of such personal information, the individuals and/or merchants may be provided with an opportunity to control whether such information is collected or to control whether and/or how such information is used. In addition, certain data may be processed in one or more ways before it is stored or used, so that personally identifiable information is removed. For example, an individual's identity may be processed so that no personally identifiable information can be determined for the individual, or an individual's geographic location may be generalized where location data is obtained (such as to a city, ZIP code, or state level), so that a particular location of an individual cannot be determined. Moreover, certain information about a particular merchant may be generalized or aggregated to information about an associated merchant type, to obscure merchant-level data.

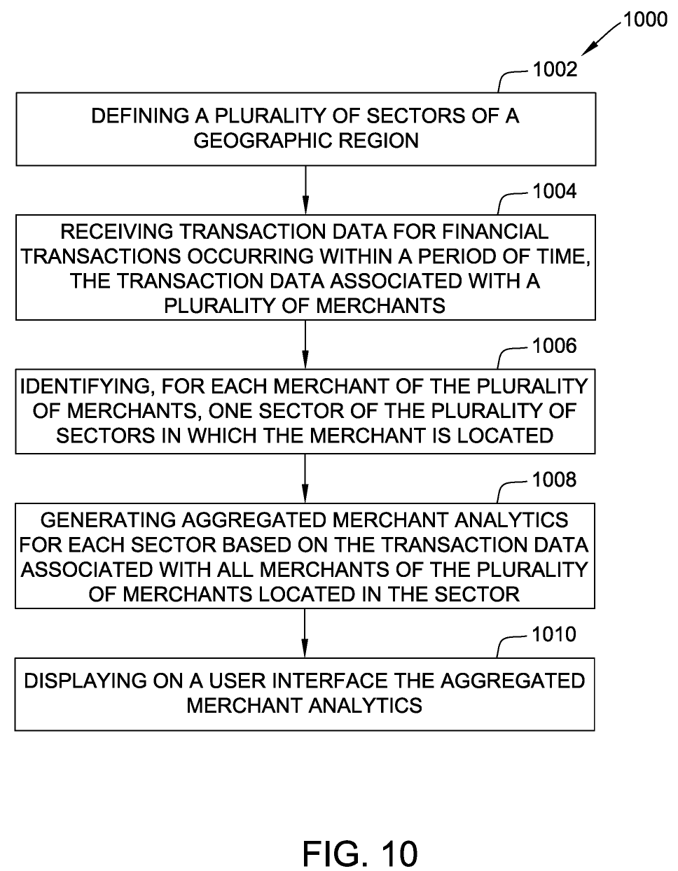

FIG. 10 is a simplified diagram of an example method 1000 for generating merchant analytics for a sector and providing the analytics on a user interface using merchant analytics computing device 112 (shown in FIG. 2). Specifically, merchant analytics computing device 112 defines 1002 a plurality of sectors of a geographic region. Additionally, merchant analytics computing device 112 receives 1004 transaction data (e.g., transaction data 540, shown in FIG. 5) for a period of time. The transaction data may be associated with a plurality of merchants, and the plurality of merchants may be located in the geographic region. Additionally, merchant analytics computing device 112 identifies 1006, for each merchant of the plurality of merchants, one sector of the plurality of sectors in which the merchant is located. Additionally, merchant analytics computing device 112 generates 1008 aggregated merchant analytics (e.g., as output 590, also shown in FIG. 5) for each sector based on the transaction data associated with all merchants of the plurality of merchants located in the sector. The aggregated merchant analytics may represent a ranking of each sector relative to all other sectors of the plurality of sectors. Additionally, merchant analytics computing device 112 displays 1010 on a user interface (e.g., user interface 118, shown in FIG. 2) the aggregated merchant analytics. The aggregated merchant analytics may be graphically represented on a map of the defined sectors. “Display,” as used in reference to merchant analytics computing device 112, may refer to any method in which merchant analytics computing device 112 facilitates or causes display of the merchant analytics on the user computing device.

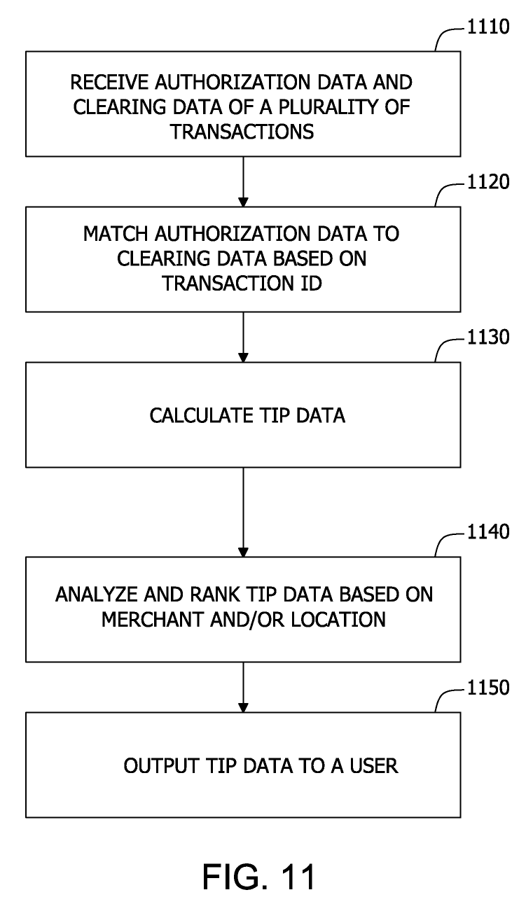

FIG. 11 is a diagram illustrating an example of a gratuity analyzing method in accordance with an example embodiment of the present disclosure. In this example, merchant analytics computing device 112 receives 1110 authorization data and clearing data of a plurality of transactions. For example, the authorization data and the clearing data may be received automatically based on a predetermined timer, at various intervals. As another example, the authorization data and the clearing data may be received in response to a request or a query for the authorization data and the clearing data that is received from the computing device. For example, the authorization data and the clearing data may be transaction data generated during a time period that may be identified by the query transmitted by the computing device. As a non-limiting example, the time period may be the previous week, the previous month, the previous year, and the like. Also, to determine trending information, the period of time information may include a period of time that is in the past, for example, a period of time from a year ago, and the like.

Based on the authorization data and the clearing data, merchant analytics computing device 112 matches 1120 authorization data from a respective transaction to transaction data from the same transaction. For example, a table may be generated in which transaction identifiers included in authorization data from a plurality of transactions is respectively matched with transaction identifiers included in clearing data from the plurality of transactions. In this example, the computing device may determine that an authorization message matches a clearing message based on one or more transaction identifiers common to both an authorization message and a clearing message.

According to various examples, merchant analytics computing device 112 calculates 1130 tip data for the plurality of transactions. Based on the matched transaction data, the payment processor may determine gratuities paid by cardholders for the respective transactions, for example, based on a difference in payment amount between a total payment amount of the clearing data and a total payment amount of the authorization data of a corresponding transaction. The payment processor may determine gratuities for a plurality of transactions based on purchases by a plurality of different users. Also, the gratuity information may be stored by the payment processor.

The merchant analytics computing device 112 analyzes 1140 the calculated tip data and a plurality of merchants to determine the tip size score. Alternatively or additionally, merchants may be ranked against each other based on the calculated tip data thereof. For example, in response to a user input for a particular location, tip data of a plurality of different merchants may be compared with each other, and a ranking from best to worst tip data may be generated and provided to the user. In this example, the tip data may include an average amount of tip, an average tip percentage, and/or an indication as to whether the tip percentage is trending up or down. As another example, tip data of a plurality of similar types of business in a particular location may be grouped together. For example, a type of merchant such as barbershops in the same neighborhood, zip code, city, county, and the like, may be analyzed and tip data from the barbershops may be aggregated to generate tip data for a type of business in a particular location.

The aggregation may be performed for similar types of businesses. Accordingly, tip data of a group of merchants of a first type of business may be compared with tip data of a different group of merchants of a second type of business located in the same location. As another example, different locations may be compared with each other. For example, tip data from a group of merchants of a first type of business in a first location may be aggregated. Also, tip data of a group of merchants of the first type of business but located in a second location may be aggregated. Accordingly, tip data of groups of businesses in different locations may be compared with each other. For example, tip data of a group of hair salons located in Kansas City, Mo. may be compared with tip data of a group of hair salons located in St. Louis, Mo.

Merchant analytics computing device 112 outputs 1150 the tip size score (e.g., as part of the user interface described herein) and/or outputs compared and ranked tip data of the merchants from one or more locations. For example, the ranked tip data may be displayed through a web browser on a screen of a user computer. As another example, the ranked tip data may be transmitted to a mobile device of the user through a mobile application, and the ranked tip data may be displayed on a screen of the mobile device.

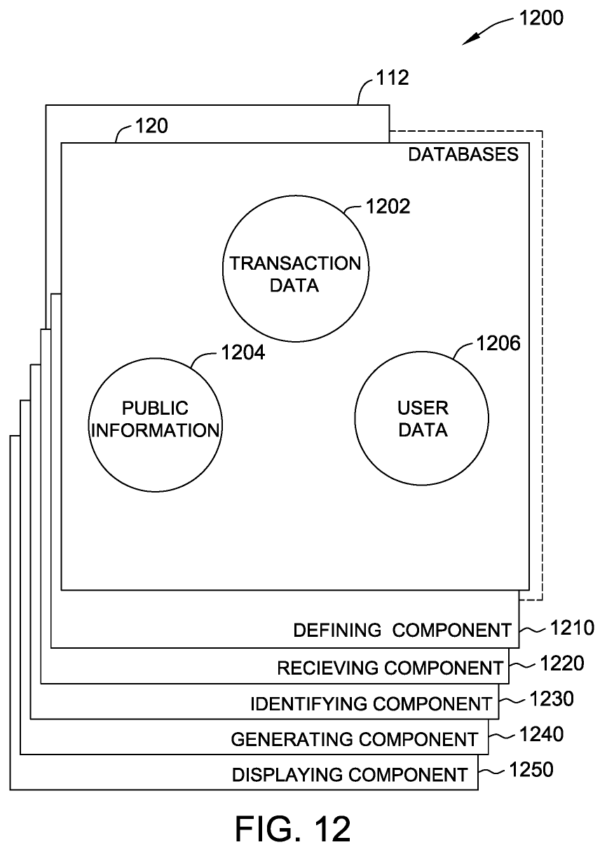

FIG. 12 is a diagram of components of one or more example computing devices that may be used in the environment shown in FIG. 2. FIG. 12 further shows a configuration of databases including at least database 120 (shown in FIG. 2). Database 120 may store information such as, for example, transaction data 1202, public information 1204, and user data 1206. Database 120 is coupled to several separate components within merchant analytics computing device 112, which perform specific tasks.

Merchant analytics computing device 112 includes a defining component 1210 for defining a plurality of sectors of a geographic region. Additionally, merchant analytics computing device 112 includes a receiving component 1220 for receiving transaction data for financial transactions occurring within a period of time. The transaction data is associated with a plurality of merchants, and the plurality of merchants are located in the geographic region. Additionally, merchant analytics computing device 112 includes an identifying component 1230 for, for each merchant of the plurality of merchants, one sector of the plurality of sectors in which the merchant is located. Additionally, merchant analytics computing device 112 includes a generating component 1240 for generating aggregated merchant analytics for each sector based on the transaction data associated with all merchants of the plurality of merchants located in the sector. The aggregated merchant analytics represent a ranking of each sector relative to all other sectors of the plurality of sectors. Additionally, merchant analytics computing device 112 includes a displaying component 1250 (alternatively referred to as a “display component”) for displaying on a user interface the aggregated merchant analytics. The aggregated merchant analytics are graphically represented on a map of the defined sectors.

In some implementations, generating component 1240 (or any other component of merchant analytics computing device 112) may be further configured to calculate a growth of each sector using received transaction data for a subset of the plurality of merchants located in each corresponding sector. The growth represents a difference in total sales revenue in each sector from a beginning of the period of time to an end of the period of time. Generating component 1240 may be further configured to determine a relative ranking for each sector by comparing the growth of each sector of the plurality of sectors and generate the growth score for each sector based on the relative ranking.

In some implementations, generating component 1240 (or any other component of merchant analytics computing device 112) may be further configured to calculate a stability of each sector using received transaction data for a subset of the plurality of merchants located in each corresponding sector. The stability represents maintenance of total sales revenue within a range of values around an average value of the total sales revenue in each sector during the period of time. Generating component 1240 may be further configured to determine a relative ranking for each sector by comparing the stability of each sector of the plurality of sectors, and generate the stability score for each sector based on the relative ranking.

In some implementations, generating component 1240 (or any other component of merchant analytics computing device 112) may be further configured to calculate a size of each sector using received transaction data for a subset of the plurality of merchants located in each corresponding sector. The size represents a total sales revenue in each sector during the period of time. Generating component 1240 may be further configured to determine a relative ranking for each sector by comparing the size of each sector of the plurality of sectors, and generate the size score for each sector based on the relative ranking.

In some implementations, generating component 1240 (or any other component of merchant analytics computing device 112) may be further configured to calculate a traffic of each sector using received transaction data for a subset of the plurality of merchants located in each corresponding sector. The traffic represents a number of transactions initiated in each sector during the period of time. Generating component 1240 may be further configured to determine a relative ranking for each sector by comparing the traffic of each sector of the plurality of sectors, and generate the traffic score for each sector based on the relative ranking.

In some implementations, generating component 1240 (or any other component of merchant analytics computing device 112) may be further configured to calculate an average ticket size for each sector using received transaction data for a subset of the plurality of merchants located in each corresponding sector. The average ticket size represents an average transaction amount in each sector during the period of time, and the average ticket size may be calculated by dividing a total sales revenue for a sector by a number of transactions initiated in the sector during the period of time. Generating component 1240 may be further configured to determine a relative ranking for each sector by comparing the average ticket size of each sector of the plurality of sectors, and generate the ticket size score for each sector based on the relative ranking.

In some implementations, generating component 1240 (or any other component of merchant analytics computing device 112) may be further configured to calculate an average tip size for each sector using received transaction data for a subset of the plurality of merchants located in each corresponding sector. The average tip size represents an average amount of gratuity per transaction in each sector during the period of time, and the average tip size may be calculated by averaging the difference between the cleared transaction amount and the authorization transaction amount for each transaction initiated in the sector during the period of time. Generating component 1240 may be further configured to determine a relative ranking for each sector by comparing the average tip size of each sector of the plurality of sectors, and generate the tip size score for each sector based on the relative ranking.

In some implementations, generating component 1240 (or any other component of merchant analytics computing device 112) may be further configured to generate a growth score for each sector. The growth score represents a first relative ranking of the plurality of sectors based on a difference in total sales revenue in each sector from a beginning of the period of time to an end of the period of time. Generating component 1240 may also be configured to generate a stability score for each sector. The stability score represents a second relative ranking of the plurality of sectors based on a maintenance of a total sales revenue within a range of values around an average value of the total sales revenue in each sector during the period of time. Generating component 1240 may be further configured to generate a size score for each sector. The size score represents a third relative ranking of the plurality of sectors based on the total sales revenue in each sector during the period of time. Generating component 1240 may also be configured to generate a traffic score each sector. The traffic score represents a fourth relative ranking of the plurality of sectors based on a number of transactions initiated in each sector during the period of time. Generating component 1240 may further be configured to generate a ticket size score for each sector. The ticket size score represents a fifth relative ranking of the plurality of sectors based on an average transaction amount in each sector during the period of time. Generating component 1240 may further be configured to generate a tip size score for each sector. The tip size score represents a sixth relative ranking of the plurality of sectors based on the average tip size per transaction in each sector during the period of time. Generating component 1240 may further be configured to generate a sub-composite score for each sector. The sub-composite score represents a seventh relative ranking of the plurality of sectors based on the average tip size per average ticket size for each transaction in each sector during the period of time. Generating component 1240 may still further be configured to generate the composite score for each sector. The composite score represents an eighth relative ranking of the plurality of sectors based on an aggregation of the growth score, the stability score, the size score, the traffic score, and the ticket size score of each sector.

In some implementations, generating component 1240 may be configured to generate a merchant record for each merchant of the plurality of merchants. Receiving component 1720 may be configured to receive an investment goal associated with the plurality of merchants. Identifying component 1230 may be configured to sort the plurality of merchant records according to the investment goal and the merchant analytics for each sector in which each merchant of the plurality of merchants is located. Causing or displaying component 1250 may be configured to present the sorted merchant records in an optimized merchant management portfolio.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A merchant analytics computing device for generating aggregated merchant analytics for a geographic sector using tip data, said merchant analytics computing device comprising a memory in communication with a processor programmed to:
define a plurality of sectors of a geographic region;
receive transaction data for financial transactions occurring within a period of time, the transaction data associated with a plurality of merchants, the plurality of merchants located in the geographic region, the transaction data including authorization data messages and clearing data messages;
match, for each merchant of the plurality of merchants, a plurality of authorization data messages with a respective plurality of clearing data messages;
calculate a tip size for each of the plurality of matched transactions;
identify, for each merchant of the plurality of merchants, one sector of the plurality of sectors in which the merchant is located;
generate aggregated merchant analytics for each sector based on the transaction data associated with all merchants of the plurality of merchants located in the sector, wherein the aggregated merchant analytics represent a ranking of each sector relative to all other sectors of the plurality of sectors, the aggregated merchant analytics including at least a tip size score based on the calculated tip size; and
display on a user interface of the user computing device the aggregated merchant analytics, wherein the aggregated merchant analytics are graphically represented on a map of the defined sectors.

2. The merchant analytics computing device of claim 1, wherein the plurality of merchants includes a plurality of eating establishments.

3. The merchant analytics computing device of claim 1, wherein said processor is further programmed to:
calculate an average ticket size for each sector using received transaction data for each of the plurality of merchants located in each corresponding sector, wherein the average ticket size represents an average transaction amount in each sector during the period of time, and wherein the average ticket size is calculated by dividing a total sales revenue for a sector by a number of transactions initiated in the sector during the period of time;
determine a relative ranking for each sector by comparing the average ticket size of each sector of the plurality of sectors; and
generate the ticket size score for each sector based on the relative ranking.

4. The merchant analytics computing device of claim 3, wherein said processor is further programmed to generate a sub-composite score for each sector, wherein the sub-composite score represents a relative ranking of the plurality of sectors based on an aggregation of the ticket size score and the tip size score of each sector.

5. The merchant analytics computing device of claim 1, wherein said processor is further programmed to:
provide an option on the user interface for filtering the plurality of merchants into eating establishments and non-eating establishments, and;
only generate the tip size score for the eating establishments.

6. The merchant analytics computing device of claim 1, wherein said processor is further programmed to:
generate a growth score for each sector, wherein the growth score represents a first relative ranking of the plurality of sectors based on a difference in total sales revenue in each sector from a beginning of the period of time to an end of the period of time;
generate a stability score for each sector, wherein the stability score represents a second relative ranking of the plurality of sectors based on a maintenance of a total sales revenue within a range of values around an average value of the total sales revenue in each sector during the period of time;
generate a size score for each sector, wherein the size score represents a third relative ranking of the plurality of sectors based on the total sales revenue in each sector during the period of time;
generate a traffic score each sector, wherein the traffic score represents a fourth relative ranking of the plurality of sectors based on a number of transactions initiated in each sector during the period of time;
generate a ticket size score for each sector, wherein the ticket size score represents a fifth relative ranking of the plurality of sectors based on an average transaction amount in each sector during the period of time; and
generate a composite score for each sector, wherein the composite score represents a sixth relative ranking of the plurality of sectors based on an aggregation of the growth score, the stability score, the size score, the traffic score, the ticket size score, and the tip size score of each sector.

7. The merchant analytics computing device of claim 1, wherein said processor is further programmed to calculate a tip size for each of the plurality of matched transactions by determining a difference between each of the plurality of authorization data messages and each of the corresponding clearing data messsages.

8. A method for generating aggregated merchant analytics for a geographic sector using tip data, said method implemented by a merchant analytics computing device including at least one processor in communication with a memory, the merchant analytics computing device in communication with a user computing device, said method comprising:
defining a plurality of sectors of a geographic region;
receiving, by the merchant analytics computing device, transaction data for financial transactions occurring within a period of time, the transaction data associated with a plurality of merchants, the plurality of merchants located in the geographic region, the transaction data including authorization data messages and clearing data messages;
matching, for each merchant of the plurality of merchants, a plurality of authorization data messages with a respective plurality of clearing data messages;
calculating a tip size for each of the plurality of matched transactions;
identifying, for each merchant of the plurality of merchants, one sector of the plurality of sectors in which the merchant is located;
generating aggregated merchant analytics for each sector based on the transaction data associated with all merchants of the plurality of merchants located in the sector, wherein the aggregated merchant analytics represent a ranking of each sector relative to all other sectors of the plurality of sectors, the aggregated merchant analytics including at least a tip size score based on the calculated tip size; and
displaying on a user interface of the user computing device the aggregated merchant analytics, wherein the aggregated merchant analytics are graphically represented on a map of the defined sectors.

9. The method of claim 8, wherein the plurality of merchants includes a plurality of eating establishments.

10. The method of claim 8 further comprising:
calculating an average ticket size for each sector using received transaction data for each of the plurality of merchants located in each corresponding sector, wherein the average ticket size represents an average transaction amount in each sector during the period of time, and wherein the average ticket size is calculated by dividing a total sales revenue for a sector by a number of transactions initiated in the sector during the period of time;
determining a relative ranking for each sector by comparing the average ticket size of each sector of the plurality of sectors; and
generating the ticket size score for each sector based on the relative ranking.

11. The method of claim 10 further comprising generating a sub-composite score for each sector, wherein the sub-composite score represents a relative ranking of the plurality of sectors based on an aggregation of the ticket size score and the tip size score of each sector.

12. The method of claim 8 further comprising:
providing an option on the user interface for filtering the plurality of merchants into eating establishments and non-eating establishments, and;
only generating the tip size score for the eating establishments.

13. The method of claim 8 further comprising:
generating a growth score for each sector, wherein the growth score represents a first relative ranking of the plurality of sectors based on a difference in total sales revenue in each sector from a beginning of the period of time to an end of the period of time;
generating a stability score for each sector, wherein the stability score represents a second relative ranking of the plurality of sectors based on a maintenance of a total sales revenue within a range of values around an average value of the total sales revenue in each sector during the period of time;
generating a size score for each sector, wherein the size score represents a third relative ranking of the plurality of sectors based on the total sales revenue in each sector during the period of time;
generating a traffic score each sector, wherein the traffic score represents a fourth relative ranking of the plurality of sectors based on a number of transactions initiated in each sector during the period of time;
generating a ticket size score for each sector, wherein the ticket size score represents a fifth relative ranking of the plurality of sectors based on an average transaction amount in each sector during the period of time; and
generating a composite score for each sector, wherein the composite score represents a sixth relative ranking of the plurality of sectors based on an aggregation of the growth score, the stability score, the size score, the traffic score, the ticket size score, and the tip size score of each sector.

14. The method of claim 8 further comprising calculating a tip size for each of the plurality of matched transactions by determining a difference between each of the plurality of authorization data messages and each of the corresponding clearing data messsages.

15. A computer-readable storage medium having computer-executable instructions embodied thereon, wherein when executed by a merchant analytics computing device including at least one processor in communication with a memory, the computer-readable instructions cause the merchant analytics computing device to:
define a plurality of sectors of a geographic region;
receive transaction data for financial transactions occurring within a period of time, the transaction data associated with a plurality of merchants, the plurality of merchants located in the geographic region, the transaction data including authorization data messages and clearing data messages;
match, for each merchant of the plurality of merchants, a plurality of authorization data messages with a respective plurality of clearing data messages;
calculate a tip size for each of the plurality of matched transactions;
identify, for each merchant of the plurality of merchants, one sector of the plurality of sectors in which the merchant is located;
generate aggregated merchant analytics for each sector based on the transaction data associated with all merchants of the plurality of merchants located in the sector, wherein the aggregated merchant analytics represent a ranking of each sector relative to all other sectors of the plurality of sectors, the aggregated merchant analytics including at least a tip size score based on the calculated tip size; and
display on a user interface of the user computing device the aggregated merchant analytics, wherein the aggregated merchant analytics are graphically represented on a map of the defined sectors.

16. The computer-readable storage medium of claim 15, wherein the plurality of merchants includes a plurality of eating establishments.

17. The computer-readable storage medium of claim 15, wherein the computer-executable instructions further cause the merchant analytics computing device to:
calculate an average ticket size for each sector using received transaction data for each of the plurality of merchants located in each corresponding sector, wherein the average ticket size represents an average transaction amount in each sector during the period of time, and wherein the average ticket size is calculated by dividing a total sales revenue for a sector by a number of transactions initiated in the sector during the period of time;
determine a relative ranking for each sector by comparing the average ticket size of each sector of the plurality of sectors; and
generate the ticket size score for each sector based on the relative ranking.

18. The computer-readable storage medium of claim 17, wherein the computer-executable instructions further cause the merchant analytics computing device to generate a sub-composite score for each sector, wherein the sub-composite score represents a relative ranking of the plurality of sectors based on an aggregation of the ticket size score and the tip size score of each sector.

19. The computer-readable storage medium of claim 15, wherein the computer-executable instructions further cause the merchant analytics computing device to:
provide an option on the user interface for filtering the plurality of merchants into eating establishments and non-eating establishments, and;
only generate the tip size score for the eating establishments.

20. The computer-readable storage medium of claim 15, wherein the computer-executable instructions further cause the merchant analytics computing device to:
generate a growth score for each sector, wherein the growth score represents a first relative ranking of the plurality of sectors based on a difference in total sales revenue in each sector from a beginning of the period of time to an end of the period of time;
generate a stability score for each sector, wherein the stability score represents a second relative ranking of the plurality of sectors based on a maintenance of a total sales revenue within a range of values around an average value of the total sales revenue in each sector during the period of time;
generate a size score for each sector, wherein the size score represents a third relative ranking of the plurality of sectors based on the total sales revenue in each sector during the period of time;
generate a traffic score each sector, wherein the traffic score represents a fourth relative ranking of the plurality of sectors based on a number of transactions initiated in each sector during the period of time;
generate a ticket size score for each sector, wherein the ticket size score represents a fifth relative ranking of the plurality of sectors based on an average transaction amount in each sector during the period of time; and
generate a composite score for each sector, wherein the composite score represents a sixth relative ranking of the plurality of sectors based on an aggregation of the growth score, the stability score, the size score, the traffic score, the ticket size score, and the tip size score of each sector.
